(19) United States
(12) Patent Application Publication
(10) Pub. No.: US 2018/0124359 A1
(43) Pub. Date: May 3, 2018

(54) PHASED EXPERIENCES FOR TELECOMMUNICATION SESSIONS

(71) Applicant: Microsoft Technology Licensing, LLC, Redmond, WA (US)

(72) Inventor: Jason Thomas Faulkner, Seattle, WA (US)

(21) Appl. No.: 15/339,781

(22) Filed: Oct. 31, 2016

(51) Int. Cl. H04N 7/15; H04L 29/06; H04L 12/26

(52) U.S. Cl. CPC H04N 7/152; H04L 43/16; H04L 65/403; H04L 65/1069

(57) ABSTRACT

A system hosting a telecommunications session is disclosed. The system hosts a telecommunication session between a plurality of client computing devices. The session includes a number of phases, including a first phase, a second phase and a third phase. The first phase is associated with a graphical arrangement showing a number of video streams, and the second phase is associated with a graphical arrangement showing a reduced number of video streams to bring focus to salient actions or material. A third phase provides summary data for enabling users to view and edit material related to the meeting, including salient portions of video streams and other forms of content.

### BACKGROUND

At present, the use of videoconferencing systems in commercial and corporate settings has increased dramatically in facilitating meetings and conferences between people in remote locations, reducing the need for travel so as to bring these people physically together in order to conduct the meetings or conferences. In general, videoconferencing systems allow users (i.e., people) of a videoconferencing system, in two or more remote locations, to communicate interactively with each other via live, simultaneous two-way video streams, audio streams, or both. Some videoconferencing systems (such as, for example, Cisco WebEx provided by Cisco Systems, Inc. of San Jose, Calif., GoToMeeting provided by Citrix Systems, Inc. of Santa Clara, Calif., Zoom provided by Zoom Video Communications of San Jose, Calif., Google Hangouts by Alphabet Inc. of Mountain View, Calif., and Skype provided by Microsoft Corporation, of Redmond, Wash.) also allow users to exchange digital documents or shared virtual locations such as, for example, images, text, video, applications, online locations, social media and any others.

A limitation of some videoconferencing systems is that they do not allow users to experience, engage or follow the action of typical interactions that occur at live meetings when all the users are physically present at the same location. Most videoconferencing systems utilize remote communication devices (such as, for example, video terminals, personal computers, Mixed/virtual reality (both desktop and portable) and mobile devices such as, for example, tablets, smartphones, etc.) that display video and play audio from the meeting, or conference, on a video display that may vary in size from approximately 3 inches to approximately 65 inches based on the type of communication devices or video display. As a result, the remote users of the videoconferencing system are typically limited to observing the interactions of the meeting, or conference, through a “window” or series of windows of the meeting, or conference, produced by the video display, which may be the screen of a mobile device, computer monitor, or large video display. Often establishing a heavy cognitive tax on the user to determine where and who the action is pertaining to.

This results in a user interface that produces a flat “thumbnail” style people and content experience for the remote users of the videoconferencing system attending the meeting or conference. Generally, this user interface only allows users to see framed individuals (i.e., other people attending the meeting or conference) in a gallery experience with a lot of negative space in the user interface that is not engaging or immersive for the remote users.

In the current model, when participants are connected in a telecommunications conferencing session, it is not readily apparent to other users when someone makes a gesture or shares a paper document, ultimately where the action is at that moment. Users that are participating in the meeting over a telecommunications session cannot see activity within a room of meeting participants. They do not have the same experience or awareness of witnessing users turn pages, seeing what other people are looking at, move in and out of space, seeing users respond to each other (like a gesture of approval or disapproval).

Additionally, the remote users are simply monitoring cameras from fixed positions which may be located either at the location of the physical meeting, or conference, or at the location of other remote users attending the meeting, or conference. Moreover, in some videoconferencing systems, some remote users may see multiple displays of fixed streams of video data on their video displays. As such, these remote users are sometimes forced to move between different views of the multiple displays of the fixed streams of video data utilizing manual controls in the user interface. As a result, these types of videoconferencing systems typically rely on the remote user attempting to decide what is important in a live meeting or conference. However, since the remote user is not physically present at the meeting location, the remote user is not able to detect or view any salient actions or materials that participants at the meeting are able to appreciate by virtue of being at present at the meeting location. As an example, when participants are engaged in a videoconferencing session, it is not readily apparent to remote users when someone makes a gesture or shares a paper document or speaking. Remote users cannot see activity within the conference room and resultantly do not have the same experience of watching other users turn pages, seeing what other users are looking at, or see other users respond to each other (through for example, gestures of approval or disapproval). As such, at times this makes it difficult for the remote user to focus on what is important in the videoconference since the remote user is not able to appreciate many of the salient portions of the videoconference. Therefore, some existing user interfaces leave the remote users unengaged, uninformed, and uninterested in the shared group activity.

As such, there is a need for an improved video conferencing system that addresses these issues. It is with respect to these and other considerations that the disclosure made herein is presented.

### SUMMARY

Meetings, conferences, or both (herein generally referred to as “meetings”) in general, whether physical (i.e., were participants of the meeting physically meet within a room), remote (via telecommunications session), or hybrid (i.e., both partially physical and partially remote), have three general phases that include a starting first phase, a working second phase, and an ending third phase. The first phase is about starting the meeting with introductions were participants at the meeting meet and greet other participants and introductory information, documents, or applications are shared, presented, or quickly discussed. In the first phase the meeting may include a time limit for invited participants to join the meeting before starting the substantive portion of the meeting. The second phase is the substantive portion of the meeting where participants listen to, review presented information (that may include documents, applications, or other relevant materials or information), present, submit information materials, interact, or discuss the issues of the meeting. The third phase is the final phase of the meeting where the substantive portion of the meeting has ended and the participants submit information for the group of participants, receive information, review what was presented, or simply leave the meeting.

The disclosed system addresses the problems addressed above with regards to remote or hybrid meetings. Specifically, the disclosed system provides the same or similar experiences to remote participants of a telecommunications session as the participants that are physically attending the session at the meeting location which may be for example a room. The disclosed system allows remote participants to appreciate salient events such as, for example, noticing hand, head, or facial gestures of participants (both remote and physically located within the room of the meeting) and to focus on the salient events so as to engage the remote participants with the same experiences as the participants that are physically located at the meeting. This allows the remote participants to “follow the action” of the telecommunication session and better collaborate with the other participants (both remote and local) within the telecommunication session.

Disclosed is a system hosting a telecommunications session in accordance with the present disclosure. The system includes one or more processing units and a computer-readable medium having encoded thereon computer-executable instructions to cause the one or more processing units to receive media data at the system from a plurality of client computing devices, select a first portion of the media data based, at least in part, on phase data defining a first phase of the telecommunications session, and communicate a first arrangement dataset defining a first interface arrangement associated with the first phase of the telecommunications session to the client computing devices. The first portion of the media data is communicated from the system to the plurality of client computing devices, the first arrangement dataset causes the plurality of client computing devices to display the first portion of the media data in a first number of display portions, and the first number of display portions is based on, at least in part, on a number of participants of the telecommunications session and a first threshold. The computer-executable instructions also cause the one or more processing units to determine that the first phase of the telecommunications session is to transition to a second phase of the telecommunications session and, in response to determining that the first phase is to transition to the second phase, select a second portion of the media data based, at least in part, on the phase data defining the second phase of the telecommunications session. The second portion of the media data is communicated from the system to the plurality of client computing devices. Moreover, the computer-executable instructions also cause the one or more processing units to communicate a second arrangement dataset defining a second interface arrangement associated with the second phase of the telecommunications session to the plurality of client computing devices. The second arrangement dataset causes the plurality of client computing devices to display the second portion of the media data in a second number of display portions arranged to bring focus to the second portion of the media data. Furthermore, the second number of display portions is based on, at least in part, on a second threshold and the second threshold limits the client computing devices to display a fewer number of display portions than the first threshold.

In an example of operation, the system performs a method that includes receiving the media data at the system from a plurality of client computing devices, select a first portion of the media data based, at least in part, on phase data defining a first phase of the telecommunications session, and communicate a first arrangement dataset defining a first interface arrangement associated with the first phase of the telecommunications session to the client computing devices. The first portion of the media data is communicated from the system to the plurality of client computing devices, the first arrangement dataset causes the plurality of client computing devices to display the first portion of the media data in a first number of display portions, and the first number of display portions is based on, at least in part, on a number of participants of the telecommunications session and the first threshold. The method also includes determining that the first phase of the telecommunications session is to transition to a second phase of the telecommunications session and, in response to determining that the first phase is to transition to the second phase, select a second portion of the media data based, at least in part, on the phase data defining the second phase of the telecommunications session. The second portion of the media data is communicated from the system to the plurality of client computing devices. Moreover, the method also includes communicating a second arrangement dataset defining a second interface arrangement associated with the second phase of the telecommunications session to the plurality of client computing devices. The second arrangement dataset causes the plurality of client computing devices to display the second portion of the media data in a second number of display portions arranged to bring focus to the second portion of the media data. Furthermore, the second number of display portions is based on, at least in part, on the second threshold and the second threshold limits the client computing devices to display a fewer number of display portions than the first threshold.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a diagram illustrating an example of a system for providing phased experiences for a telecommunications session in accordance with the present disclosure.

FIG. 2 is a system block diagram illustrating components of an example device, shown in FIG. 1, configured to provide the telecommunications session between the client computing devices in accordance with the present disclosure.

FIG. 3 is an example timeline illustrating a timeline for providing phased experiences for the telecommunications session in accordance with the present disclosure.

FIG. 4 is a flow diagram of an example of an implementation of a method for providing phased experiences for telecommunications sessions in accordance with the present disclosure.

FIG. 5A is an example of a display of a first phase of the telecommunications session on a client computing device in communication with the teleconferencing system of FIG. 1 with a second person joining the telecommunications session displayed edge-to-edge on a display of the client computing device in accordance with the present disclosure.

FIG. 5B is an example of another display of the first phase of the telecommunications session on the client computing device with a third person joining the telecommunications session where the three people are displayed edge-to-edge on the display of the client computing device in accordance with the present disclosure.

FIG. 5C is an example of another display of the first phase of the telecommunications session on the client computing device with a fourth person joining the telecommunications session where the four people are displayed edge-to-edge on the display of the client computing device in accordance with the present disclosure.

FIG. 5D is an example of another display of the first phase of the telecommunications session on the client computing device with a fifth person joining the telecommunications session where the five people are displayed edge-to-edge on the display of the client computing device in accordance with the present disclosure.

FIG. 5E is an example of another display of the first phase of the telecommunications session on the client computing device with at least five people attending telecommunications session where the four people and one avatar are displayed edge-to-edge on the display of the client computing device in accordance with the present disclosure.

FIG. 5F is an example of another display of the first phase of the telecommunications session on the client computing device with a plurality of people attending telecommunications session where four people and one group of people are displayed edge-to-edge on the display of the client computing device in accordance with the present disclosure.

FIG. 5G is an example of another display of the first phase of the telecommunications session on the client computing device with at least four people attending telecommunications session where the four people and one type of content are displayed edge-to-edge on the display of the client computing device in accordance with the present disclosure.

FIG. 6A is an example of a display of the second phase of the telecommunications session on the client computing device in communication with the teleconferencing system of FIG. 1 showing at least two people attending the second phase of the telecommunications session in accordance with the present disclosure.

FIG. 6B is an example of another display of the second phase of the telecommunications session on the client computing device showing content being displayed and five people attending the second phase of the telecommunications session in accordance with the present disclosure.

FIG. 6C is an example of another display of the second phase of the telecommunications session on the client computing device showing content and one person being displayed in accordance with the present disclosure.

FIG. 7 is an example of a display of the third phase of the telecommunications session in accordance with the present disclosure.

### DETAILED DESCRIPTION

Examples described herein enables a system to provide phased experiences for a telecommunications session. Specifically, disclosed is a system hosting a telecommunications session in accordance with the present disclosure. The system includes one or more processing units and a computer-readable medium having encoded thereon computer-executable instructions to cause the one or more processing units to receive media data at the system from a plurality of client computing devices, select a first portion of the media data based, at least in part, on phase data defining a first phase of the telecommunications session, and communicate a first arrangement dataset defining a first interface arrangement associated with the first phase of the telecommunications session to the client computing devices. The first portion of the media data is communicated from the system to the plurality of client computing devices, the first arrangement dataset causes the plurality of client computing devices to display the first portion of the media data in a first number of display portions, and the first number of display portions is based on, at least in part, on a number of participants of the telecommunications session and a first threshold. The computer-executable instructions also cause the one or more processing units to determine that the first phase of the telecommunications session is to transition to a second phase of the telecommunications session and, in response to determining that the first phase is to transition to the second phase, select a second portion of the media data based, at least in part, on the phase data defining the second phase of the telecommunications session. The second portion of the media data is communicated from the system to the plurality of client computing devices. Moreover, the computer-executable instructions also cause the one or more processing units to communicate a second arrangement dataset defining a second interface arrangement associated with the second phase of the telecommunications session to the plurality of client computing devices. The second arrangement dataset causes the plurality of client computing devices to display the second portion of the media data in a second number of display portions arranged to bring focus to the second portion of the media data. Furthermore, the second number of display portions is based on, at least in part, on a second threshold and the second threshold limits the client computing devices to display a fewer number of display portions than the first threshold.

In an example of operation, the system performs a method that includes receiving the media data at the system from a plurality of client computing devices, select a first portion of the media data based, at least in part, on phase data defining a first phase of the telecommunications session, and communicate a first arrangement dataset defining a first interface arrangement associated with the first phase of the telecommunications session to the client computing devices. The first portion of the media data is communicated from the system to the plurality of client computing devices, the first arrangement dataset causes the plurality of client computing devices to display the first portion of the media data in a first number of display portions, and the first number of display portions is based on, at least in part, on a number of participants of the telecommunications session and the first threshold. The method also includes determining that the first phase of the telecommunications session is to transition to a second phase of the telecommunications session and, in response to determining that the first phase is to transition to the second phase, select a second portion of the media data based, at least in part, on the phase data defining the second phase of the telecommunications session. The second portion of the media data is communicated from the system to the plurality of client computing devices. Moreover, the method also includes communicating a second arrangement dataset defining a second interface arrangement associated with the second phase of the telecommunications session to the plurality of client computing devices. The second arrangement dataset causes the plurality of client computing devices to display the second portion of the media data in a second number of display portions arranged to bring focus to the second portion of the media data. Furthermore, the second number of display portions is based on, at least in part, on the second threshold and the second threshold limits the client computing devices to display a fewer number of display portions than the first threshold.

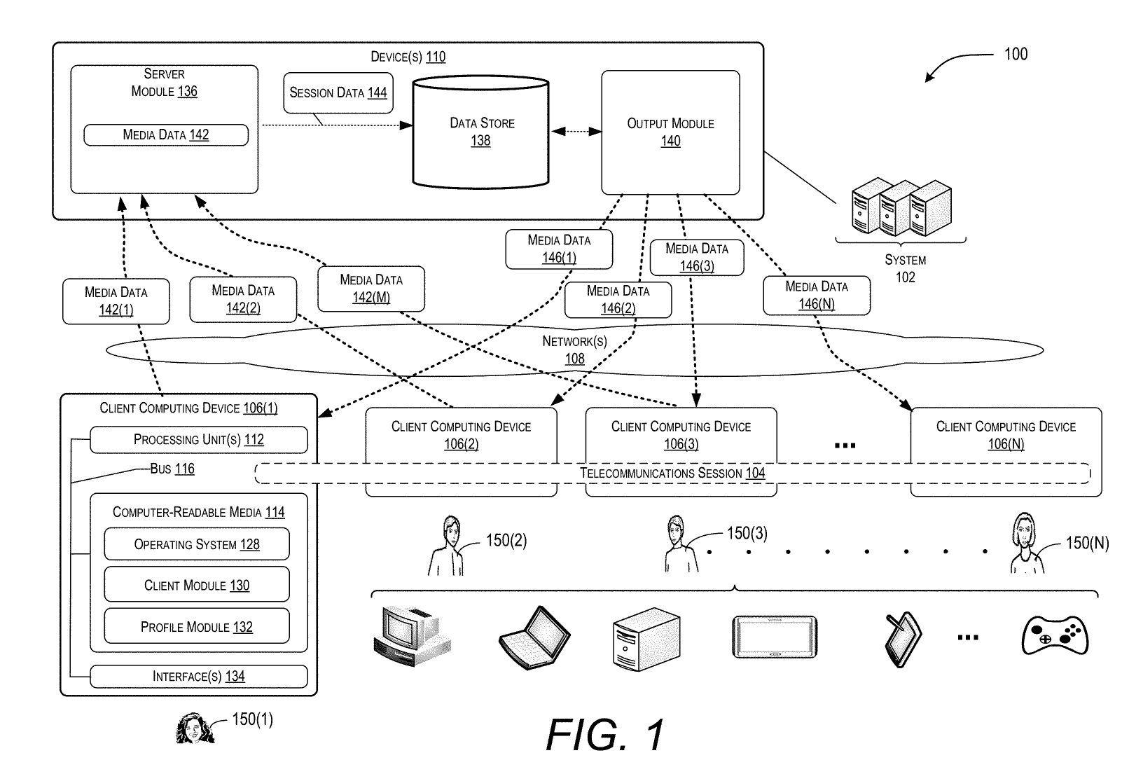

Various examples, scenarios, and aspects are described below with reference to FIGS. 1-9.

In FIG. 1, a diagram illustrating an example of a teleconferencing system 100 is shown in which a system 102 may operate to provide phased experiences for a telecommunications session 104. In this example, the telecommunications session 104 is between a number of client computing devices 106(1) through 106(N) (where N is a positive integer number having a value of two or greater). The client computing devices 106(1) through 106(N) enable users 150(1) through 150(N) (i.e., participants) to participate in the telecommunications session 104. In this example, the telecommunications session 104 may be hosted, over one or more network(s) 108, by the system 102. That is, the system 102 may provide a service that enables users 150(1) through 150(N) of the client computing devices 106(1) through 106(N) to participate in the telecommunications session 104. As an alternative, the telecommunications session 104 may be hosted by one of the client computing devices 106(1) through 106(N) utilizing peer-to-peer technologies.

The system 102 includes device(s) 110 and the device(s) 110 and/or other components of the system 102 may include distributed computing resources that communicate with one another, with the system 102, and/or with the client computing devices 106(1) through 106(N) via the one or more network(s) 108. In some examples, the system 102 may be an independent system that is tasked with managing aspects of one or more telecommunications sessions 104. As an example, the system 102 may be managed by entities such as Slack, WebEx, GoToMeeting, Google hangouts, etc.

Network(s) 108 may include, for example, public networks such as the Internet, private networks such as an institutional and/or personal intranet, or some combination of private and public networks. Network(s) 108 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 108 may utilize communications protocols, including packet-based and/or datagram-based protocols such as Internet protocol (“IP”), transmission control protocol (“TCP”), user datagram protocol (“UDP”), or other types of protocols. Moreover, network(s) 108 may also include a number of devices that facilitate network communications and/or form a hardware basis for the networks, such as switches, routers, gateways, access points, firewalls, base stations, repeaters, backbone devices, and the like.

In some examples, network(s) 108 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.11 standards (e.g., 802.11g, 802.11n, and so forth), and other standards.

In various examples, device(s) 110 may include one or more computing devices that operate in a cluster or other grouped configuration to share resources, balance load, increase performance, provide fail-over support or redundancy, or for other purposes. For instance, device(s) 110 may belong to a variety of classes of devices such as traditional server-type devices, desktop computer-type devices, and/or mobile-type devices. Thus, although illustrated as a single type of device—a server-type device—device(s) 110 may include a diverse variety of device types and are not limited to a particular type of device. Device(s) 110 may represent, but are not limited to, server computers, desktop computers, web-server computers, personal computers, mobile computers, laptop computers, tablet computers, or any other sort of computing device.

A client computing device (e.g., one of client computing device(s) 106(1) through 106(N)) may belong to a variety of classes of devices, which may be the same as, or different from, device(s) 110, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a telecommunication device, a computer navigation type client computing device such as a satellite-based navigation system including a global positioning system (“GPS”) device, a wearable device, a virtual reality (“VR”) device, an augmented reality (AR) device, an implanted computing device, an automotive computer, a network-enabled television, a thin client, a terminal, an Internet of Things (“IoT”) device, a work station, a media player, a personal video recorders (“PVR”), a set-top box, a camera, an integrated component (e.g., a peripheral device) for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc. In some implementations, a client computing device includes input/output (“I/O”) interfaces that enable communications with input/output devices such as user input devices including peripheral input devices (e.g., a game controller, a keyboard, a mouse, a pen, a voice input device, a touch input device, a gestural input device, and the like) and/or output devices including peripheral output devices (e.g., a display, a printer, audio speakers, a haptic output device, and the like).

Client computing device(s) 106(1) through 106(N) of the various classes and device types can represent any type of computing device having one or more processing unit(s) 112 operably connected to computer-readable media 114 such as via a bus 116, which in some instances can include one or more of a system bus, a data bus, an address bus, a PCI bus, a Mini-PCI bus, and any variety of local, peripheral, and/or independent buses.

Executable instructions stored on computer-readable media 114 may include, for example, an operating system 128, a client module 130, a profile module 132, and other modules, programs, or applications that are loadable and executable by processing units(s) 112.

Client computing device(s) 106(1) through 106(N) may also include one or more interface(s) 134 to enable communications between client computing device(s) 106(1) through 106(N) and other networked devices, such as device(s) 110 and/or devices of the system 102, over network(s) 108. Such network interface(s) 134 may include one or more network interface controllers (NICs) or other types of transceiver devices to send and receive communications and/or data over a network.

In the example environment 100 of FIG. 1, client computing devices 106(1) through 106(N) may use their respective client modules 124 to connect with one another and/or other external device(s) in order to participate in the telecommunications session 104. For instance, a first user 150(1) may utilize a client computing device 106(1) to communicate with a second user 150(2) of another client computing device 106(2). When executing client modules 124, the users 150(1) and 150(2) may share data, which may cause the client computing device 106(1) to connect to the system 102 and the other client computing devices 106(2) through 106(N) over the network 108.

The client computing device(s) 106(1) through 106(N) may use their respective profile module 132 to generate participant profiles, and provide the participant profiles to other client computing devices and/or to the device(s) 110 of the system 102. A participant profile may include one or more of an identity of a participant (e.g., a name, a unique identifier (“ID”), etc.), participant data, such as personal data and location data may be stored. Participant profiles may be utilized to register participants for video conferencing sessions.

As shown in FIG. 1, the device(s) 110 of the system 102 includes a server module 136, a data store 138, and an output module 140. The server module 136 is configured to receive, from individual client computing devices 106(1) through 106(N), media data 142(1) through 142(M) (where M is a positive integer number equal to 2 or greater). In some scenarios, not all the client computing devices utilized to participate in the telecommunications session 104 provide an instance of media data 142, and thus, M (the number of instances submitted) may not be equal to N (the number of client computing devices).

The server module 136 is also configured to receive, generate and communicate session data 144 and to store the session data 144 in the data store 138. In various examples, the server module 136 may select aspects of the media data 142 that are to be shared with the client computing devices 106(1) through 106(N). The output module 140 may communicate the output media data 146 to the client computing devices 106(1) through 106(N). Specifically, in this example, the output module 140 is configured to communicate output media data 146(1) to client computing device 106(1), output media data 146(2) to client computing device 106(2), output media data 146(3) to client computing device 106(3), and output media data 146(N) to client computing device 106(N), respectfully.

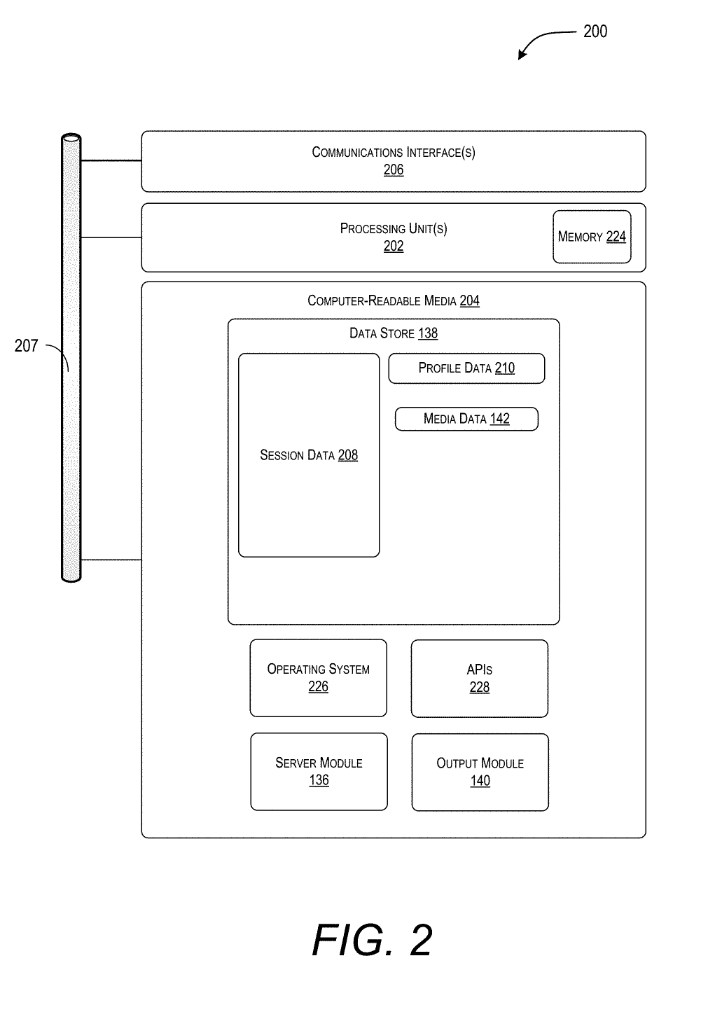

In FIG. 2, a system block diagram is shown illustrating components of an example device 200 configured to provide the telecommunications session 104 between the client computing devices, such as client computing devices 106(1) through 106(N). The device 200 may represent one of device(s) 110 where the device 200 includes one or more processing unit(s) 202, computer-readable media 204, communication interface(s) 206. The components of the device 200 are operatively connected, for example, via a bus 207, which may include one or more of a system bus, a data bus, an address bus, a PCI bus, a Mini-PCI bus, and any variety of local, peripheral, and/or independent buses.

As utilized herein, processing unit(s), such as the processing unit(s) 202 and/or processing unit(s) 112, may represent, for example, a CPU-type processing unit, a GPU-type processing unit, a field-programmable gate array (“FPGA”), another class of digital signal processor (“DSP”), or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media, such as computer-readable media 204 and/or computer-readable media 114, may store instructions executable by the processing unit(s). The computer-readable media may also store instructions executable by external processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random-access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 206 may represent, for example, network interface controllers (“NICs”) or other types of transceiver devices to send and receive communications over a network.

In the illustrated example, computer-readable media 204 includes the data store 138. In some examples, data store 138 includes data storage such as a database, data warehouse, or other type of structured or unstructured data storage. In some examples, data store 138 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 138 may store data for the operations of processes, applications, components, and/or modules stored in computer-readable media 204 and/or executed by processing unit(s) 202 and/or accelerator(s). For instance, in some examples, data store 138 may store session data 208 (e.g., session data 144), profile data 210, and/or other data. The session data 208 may include a total number of participants in the telecommunications session 104, and activity that occurs in the telecommunications session 104 (e.g., behavior, activity of the participants), and/or other data related to when and how the telecommunications session 104 is conducted or hosted. Examples of profile data 210 include, but are not limited to, a participant identity (“ID”) and other data.

Alternately, some or all of the above-referenced data can be stored on separate memories 224 on board one or more processing unit(s) 202 such as a memory on board a CPU-type processor, a GPU-type processor, an FPGA-type accelerator, a DSP-type accelerator, and/or another accelerator. In this example, the computer-readable media 204 also includes operating system 226 and application programming interface(s) 228 configured to expose the functionality and the data of the device(s) 110 (e.g., example device 200) to external devices associated with the client computing devices 106(1) through 106(N). Additionally, the computer-readable media 204 includes one or more modules such as the server module 136 and an output module 140, although the number of illustrated modules is just an example, and the number may vary higher or lower. That is, functionality described herein in association with the illustrated modules may be performed by a fewer number of modules or a larger number of modules on one device or spread across multiple devices.

As such and as described earlier, in general, the system 102 is configured to host the telecommunications session 104 with the plurality of client computing devices 106(1) through 106(N). The system 102 includes one or more processing units 202 and a computer-readable medium 204 having encoded thereon computer-executable instructions to cause the one or more processing units 202 to receive media data 142(1) through 142(M) at the system 102 from a plurality of client computing devices 106(1) through 106(N), select a first portion of the media data 142 based, at least in part, on phase data defining a first phase of the telecommunications session 104, and communicate a first arrangement dataset defining a first interface arrangement associated with the first phase of the telecommunications session 104 to the client computing devices 106(1) through 106(N). The first portion of the media data 146(1) through 146(N) is communicated from the system 102 to the plurality of client computing devices 106(1) through 106(N), the first arrangement dataset causes the plurality of client computing devices 106(1) through 106(N) to display the first portion of the media data 146(1) through 146(N) in a first number of display portions, and the first number of display portions is based on, at least in part, on a number of participants of the telecommunications session 104 and a first threshold. The computer-executable instructions also cause the one or more processing units 202 to determine that the first phase of the telecommunications session 104 is to transition to a second phase of the telecommunications session 104 and, in response to determining that the first phase is to transition to the second phase, select a second portion of the media data 146(1) through 146(N) based, at least in part, on the phase data defining the second phase of the telecommunications session 104. The second portion of the media data 142 is communicated from the system 102 to the plurality of client computing devices 106(1) through 106(N). Moreover, the computer-executable instructions also cause the one or more processing units 202 to communicate a second arrangement dataset defining a second interface arrangement associated with the second phase of the telecommunications session 104 to the plurality of client computing devices 106(1) through 106(N). The second arrangement dataset causes the plurality of client computing devices 106(1) through 106(N) to display the second portion of the media data in a second number of display portions arranged to bring focus to the second portion of the media data 146(1) through 146(N). Furthermore, the second number of display portions is based on, at least in part, on a second threshold and the second threshold limits the client computing devices 106(1) through 106(N) to display a fewer number of display portions than the first threshold.

In an example of operation, the system 102 performs a method that includes receiving the media data 142(1) through 142(N) at the system 102 from a plurality of client computing devices 106(1) through 106(N), select a first portion of the media data 142 based, at least in part, on phase data defining a first phase of the telecommunications session 104, and communicate a first arrangement dataset defining a first interface arrangement associated with the first phase of the telecommunications session 104 to the client computing devices 106(1) through 106(N). The first portion of the media data 146(1) through 146(N) is communicated from the system 102 to the plurality of client computing devices 106(1) through 106(N), the first arrangement dataset causes the plurality of client computing devices 106(1) through 106(N) to display the first portion of the media data 146(1) through 146(N) in a first number of display portions, and the first number of display portions is based on, at least in part, on a number of participants of the telecommunications session 104 and the first threshold. The method also includes determining that the first phase of the telecommunications session 104 is to transition to a second phase of the telecommunications session 104 and, in response to determining that the first phase is to transition to the second phase, select a second portion of the media data 146(1) through 146(N) based, at least in part, on the phase data defining the second phase of the telecommunications session 104. The second portion of the media data 146(1) through 146(N) is communicated from the system 102 to the plurality of client computing devices 106(1) through 106(N). Moreover, the method also includes communicating a second arrangement dataset defining a second interface arrangement associated with the second phase of the telecommunications session 104 to the plurality of client computing devices 106(1) through 106(N). The second arrangement dataset causes the plurality of client computing devices 106(1) through 106(N) to display the second portion of the media data 146(1) through 146(N) in a second number of display portions arranged to bring focus to the second portion of the media data 146(1) through 146(N). Furthermore, the second number of display portions is based on, at least in part, on the second threshold and the second threshold limits the client computing devices 106(1) through 106(N) to display a fewer number of display portions than the first threshold.

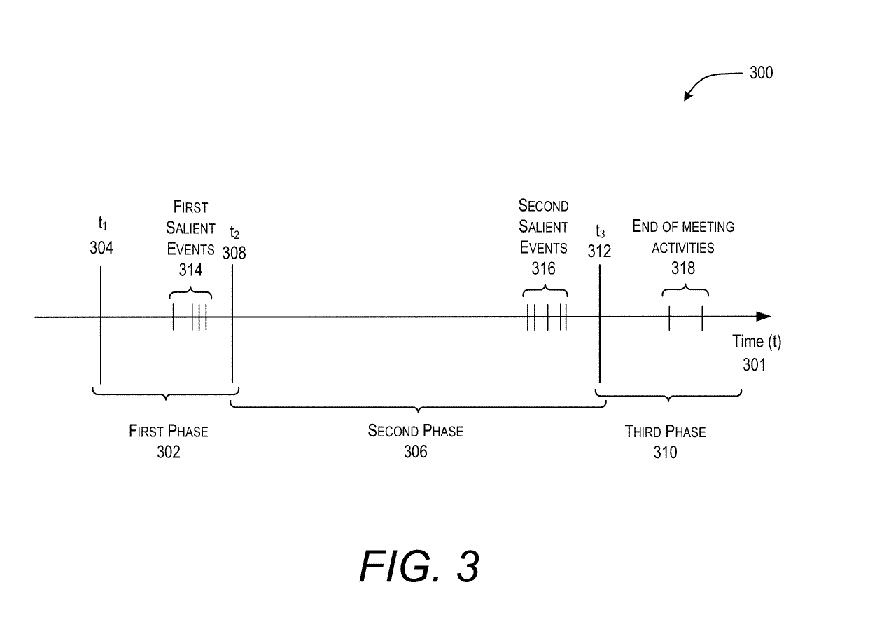

Turning to FIG. 3, an example timeline 300 is shown illustrating the three phases of operation of the system 102. The horizontal axis in FIG. 3 represents time 301, as illustrated. As referenced by 302, the first phase representing the start of the telecommunications session 104 occurs at a start of first time (e.g., time t₁) 304. As referenced by 306, the second phase of the telecommunications session 104 occurs at a start of second time (e.g., time t2) 308. Furthermore, as references by 310, the third phase representing the end of the telecommunications session 104 occurs at a start of third time (e.g., time t3) 312.

As discussed earlier, meetings in general, whether physical (i.e., participants of the meeting physically meet within a room), remote (via telecommunications session), or hybrid (i.e., both partially physical and partially remote), have three general phases that include the starting first phase 302, the working second phase 306, and the ending third phase 310. The first phase 302 is about starting the meeting with introductions were participants at the meeting meet and greet other participants and introductory information, documents, or applications are shared, presented, or quickly discussed. In the first phase 302 the meeting may include a time limit for invited participants to join the meeting before starting the substantive portion of the meeting. The second phase 306 is the substantive portion of the meeting where participants listen to, review presented information (that may include documents, applications, or other relevant materials or information), present, submit information materials, interact, or discuss the issues of the meeting. The third phase 310 is the final phase of the meeting where the substantive portion of the meeting has ended and the participants submit information for the group of participants, receive information, review what was presented, or simply leave the meeting.

In this example, the system 102 provides the same or similar experiences to remote participants of a telecommunications session 104 as the participants that are physically attending the telecommunications session 104 at the meeting location which may be for example a room. The system 102 allows remote participants to appreciate salient events such as, for example, noticing hand, head, or facial gestures of participants (both remote and physically located within the room of the meeting) and to focus on the salient events so as to immerse the remote participants with the same experiences as the participants that are physically located at the meeting. In general, the system 102 focuses the participants to the material, people, or salient events in the telecommunications session 104 be filtering the information (via the media data 142(1) through 142(M)) provided to the system 102 from the plurality of client computing devices 106(1) to 106(N) from a large amount of information to a smaller amount of information that allows participants to focus on the materials and discussions presented in the telecommunication session 104.

As such, in general, the system 102 starts the telecommunications session 104 in the first phase 302 of the telecommunications session 104 when participants establish and enter into the telecommunications session 104 at the first time 304. The system 102 receives media data 142(1) to 142(N) from the plurality of client computing devices 106(1) through 106(N) and selects a first portion of the media data to send to the client computing devices 106(1) through 106(N) for display. The system 102 then communicates a first arrangement dataset defining a first interface arrangement associated with the first phase 302 of the telecommunications session 104 to the client computing devices 106(1) through 106(N). The first arrangement dataset causes the plurality of client computing devices 106(1) through 106(N) to display the first portion of the media data in a first number of display portions and the first number of display portions is based on, at least in part, on a number of participants of the telecommunications session 104 and a first threshold. As the telecommunications session 104 continues within the first phase 302, the system 102 monitors the media data for first salient events 314 that may include, for example, active participate speakers, shared content (such as, for example, shared documents) and applications, movement of participates, facial expressions of participants, sub-times of the first phase 302, an amount of time spent in the first phase 302, etc. In this example, any first salient events 310 may cause the system 102 to change the first portion of the media data so as to display different display portions on the plurality of client computing devices 106(1) through 106(N) so as to increase the awareness of the meeting to remote participants, their locations (i.e., analog environments), activity and content attending the telecommunications session 104. Examples of the different display portions may include, for example, promoting certain more active participants in the telecommunications session 104 to display as a display portion on the displays of the plurality of client computing devices 106(1) through 106(N) based on, for example, active speaking, movement, facial expressions, submission of content and applications, etc. Moreover, the sub-times of the first phase 302 may include a predetermined time, which may be controlled by a timer in the system 102, which defaults to a panning view of the main conference room or filling of the display with images of all the participants in the meeting. It is appreciated by those of ordinary skill in the art that while a number of events or triggers are shown as notches for the first salient events 314 along the time 301 line, the number and position of the notches are for illustrative purposes only, are not to scale, and the first salient events 314 may include any number of notches within the first salient events 314 (where each notch represents either individual salient events that are also triggering events, user initiated triggers, or time triggers—generally known as “triggers”) and the time spacing or positioning are not linear.

The system 102 then determines that telecommunications session 104 is to transition to the second phase 306 of the telecommunications session 104 based on a first threshold. The first threshold may be triggered by detecting the first salient events 314 that are, in general, a first set of events that can be detected by the system 102 to trigger a change from the first phase 302 to the second phase 306. The first threshold may include, for example, obtaining a rate indicating the rate in which participants are joining the telecommunications session 104 and determining that the first phase 302 is to transition to the second phase 306 based whether the rate is below another threshold. Alternatively, the first threshold may include, for example, obtaining data indicating a total number of participants, receiving confirmation data indicating a number of participants that have joined the telecommunications session 104, and determining that the first phase is to transition to the second phase includes when the number of participants that have joined the telecommunications session 104 is within the threshold level of the total number of participants. Furthermore, the first threshold may include logic configured to detect a reduction or lack of joint activity between the participants. Moreover, the first threshold may include, for example, determining when a predetermined time period has lapsed (via a duration timer) from a start of the telecommunications session 104 and determining that the first phase is to transition to the second phase when the predetermined time period has lapsed. In general, within the first phase 302, the participants will act within certain defined behaviors and the system 102 will be detecting these behaviors to detect any first salient events 314 that will result in changing views displayed to the participants within the first phase 302. Additionally, the detection of these behaviors may also trigger a change in phase such as, for example, detecting that all invited participants are present within the telecommunications session 104 or system 102 detects that a participant signals that it is time to start the second phase 306. The first phase supports meet and greet activity that is a standard for establishing quality group engagement and activity awareness.

Once in the second phase 306 at the second time 308, the main portion of the telecommunications session 104 begins. In general, the second phase 306 is a “follow the action and collaborative” working phase of the telecommunications session 104. In the second phase 306, the system 102 communicates a second arrangement dataset defining a second interface arrangement associated with the second phase 306 of the telecommunications session 104 to the plurality of client computing devices 106(1) through 106(N). The second arrangement dataset causes the plurality of client computing devices 106(1) through 106(N) to display the second portion of the media data in a second number of display portions arranged to bring focus to the second portion of the media data within the telecommunications session 104. The second number of display portions is based on, at least in part, on a second threshold and the second threshold limits the client computing devices 106(1) through 106(N) to display a fewer number of display portions than the first threshold. Similar to the first phase 302, in the second phase 306, the system 102 monitors the media data 142(1) through 142(M) for first salient events 310 that may include, for example, active participate speakers, shared content (such as, for example, shared documents) and applications, movement of participates, facial expressions of participants, sub-times of the second phase 306, etc. In this example, any second salient events 316 may cause the system 102 to change the first portion of the media data so as to display different display portions on the plurality of client computing devices 106(1) through 106(N) so as to increase the focus of the meeting to remote participants attending the telecommunications session 104 allow them to better follow the action of the telecommunications session 104. Examples of the different display portions may include, for example, promoting certain more active participants in the telecommunications session 104 to display as a display portion on the displays of the plurality of client computing devices 106(1) through 106(N) based on, for example, active speaking, movement, facial expressions, submission of content and applications, etc. Moreover, the sub-times of the first phase 302 may include a predetermined time, which may be controlled by a timer in the system 102, which defaults to a panning view of the local room or filling of the display with images of all the participants in the meeting to help increase the awareness of the remote participants.

In this example, the second interface may include the second number of display portions and a plurality of sub-portions where the sub-portions are arranged to cover less surface area of a display surface than the second number of display portions. The second number of display portions are arranged to display salient portions (i.e., the second salient events 316) of the media data and the sub-portions are arranged to display the first portion of the media data.

The system 102 then determines that telecommunications session 104 is to transition to the third phase 310 of the telecommunications session 104 based on a second threshold. The second threshold may include, for example, obtaining receiving data indicating that a participant is leaving the telecommunications session 104 and determining that the second phase is to transition to the third phase, in response to receiving data indicating that a participant is leaving the telecommunications session 104. Alternatively, the second threshold may include, for example, determining when a predetermined time period has lapsed indicating an end of the telecommunications session 104 and determining that the second phase 306 is to transition to the third phase 310 when the predetermined time period has lapsed (e.g., the telecommunications session 104 was scheduled to last 60 minutes). An example of the a predetermined time period may include, for example, setting a timer in the system 102 to end the telecommunications session 104 at a certain time period because the room hosting the telecommunication session 104 is only available for that certain time period. The second phase 306 of the meet experience (of the telecommunication session 104) may rely on decreasing the number of non-active views/representations or user experience features/controls during the promotion of activity within the focused views to promote contextual group and content activity engagement and awareness.

Once in the third phase 310 at the third time 312, the system 102 performs end of activity session or meet experience 318 that include generating summary data of the telecommunications session 104, where the summary data includes at least one of a transcript of conversations of the telecommunications session 104 and selected video portions of the telecommunications session and, storing the summary data and the media data in a database of the system 102. The system 102 then communicates the summary data to the plurality of client computing devices 106(1) through 106(N).

The third phase 310 also supports the ability for participants of the telecommunications session 104 to “relive” recorded events of the telecommunications session 104 as well as to add to the telecommunications session 104 in real time or asynchronous time intervals. Thus promoting asynchronous people and content communication and productivity engagement. This helps resolve potential concerns of time availability due to schedule, time zone or multitasking. Recorded video, chat comments, emotive expressions, shared content, transcripts, rich timelines, tagged activity, shared timecode, etc. allow for virtual group engagement to be ongoing, adhoc, over past, current and future events. In general, the third phase 310 is designed to stimulate ongoing, new, future, or relived experiences. The third phase 310, increases group engagement across time zones, timelines, and locations and supports virtual spaces that are ongoing for synchronous and asynchronous group engagement and productivity.

Once in the third phase 310, the system 102 may include an option to extend the telecommunications session 104 by optionally re-starting the telecommunications session 104 at the first phase 302 (for example, to allow new participants to join the telecommunications session 104) or at the second phase 306 to continue the telecommunications session 104 with the original or reduced (e.g., some participants have left the telecommunications session 104) number of participants.

It is appreciated that in this example, that while the system 102 determines the first, second, and third phases 302, 306, and 310 for the live telecommunications session 104, that does not preclude other participants to join the telecommunications session 104 at different phases (either 302, 306, 310) from the original participants of the telecommunications session 104. For example, if an additional participant joins the telecommunications session 104 while the telecommunications session 104 is still in the first phase 302, that participant will also be in the first phase 302 of the telecommunications session 104 with the original plurality of participants. However, if that additional participant joins the telecommunications session 104 after the telecommunications session 104 has transitioned to the second phase 306, the additional participant will also be in the second phase 306 of the meeting without ever being in the first phase 302 of the telecommunications session 104. If the additional participant joins the telecommunications session 104 after the live meeting ended or entered into the third phase 310, the additional participant will be in initially in third phase 310 of the telecommunications session 104. However, the additional participant may choose to playback the telecommunications session 104 that is stored in the system 102 database and “re-live” the first phase 302 and second phase 306 of the telecommunications session 104. In this way, the additional participant may experience the meeting as if there and may interact with the other participants that were at the live meeting by adding input media data to the different parts of the telecommunications session 104 that is recorded and stored in the database. As such, the original participants of the live meeting may be notified that the additional participant has added comments or other content to the meeting that is stored in the databased for their later viewing. This process may be repeated by a number of other participants that include the original participants that were present at the live telecommunications session 104 and later participants that joined the recorded telecommunication session 104 and added further input media data, modify the summary data, and add annotations such that the content and information of the original live telecommunication session 104 may continue be viewed, amended, and grow in an organic fashion.

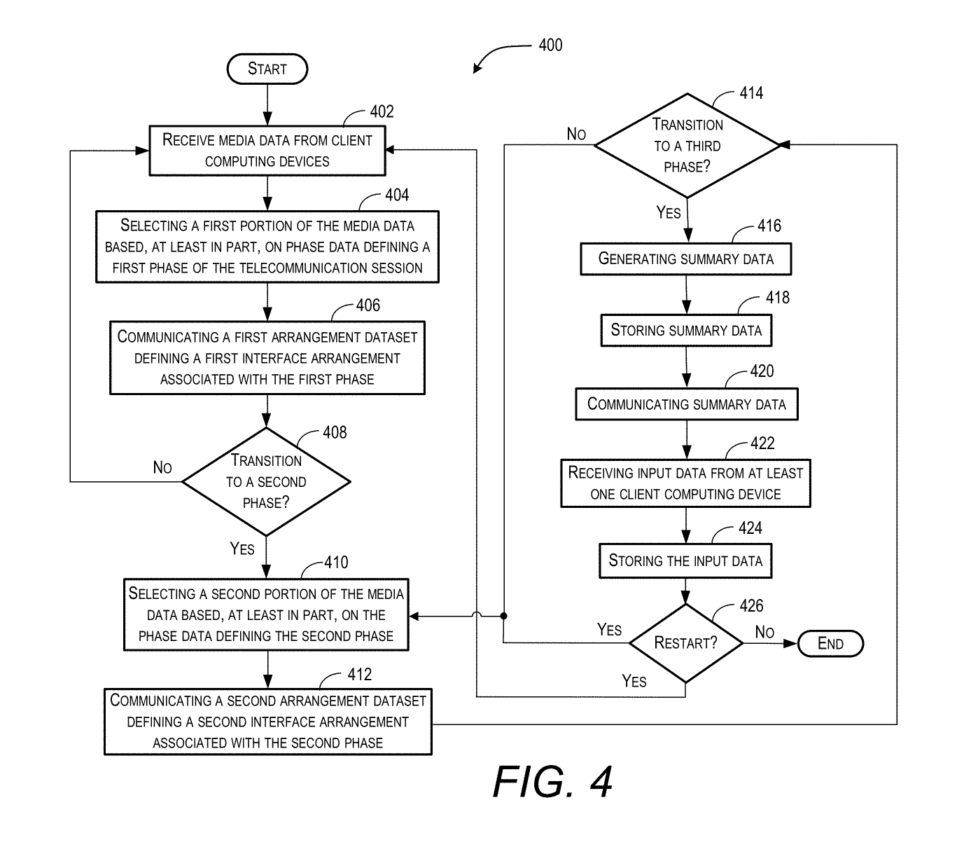

In FIG. 4, a flow diagram routine 400 of an example of an implementation of a method for providing phased experiences for telecommunications sessions 104 is shown in accordance with the present disclosure. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can end at any time and need not be performed in its entirety. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine 400 are described herein as being implemented, at least in part, by an application, component and/or circuit, such as the system 102. In some configurations, the system 102 may be a dynamically linked library (“DLL”), a statically linked library, functionality produced by an application programming interface (“API”), a compiled program, an interpreted program, a script or any other executable set of instructions. Data and/or modules, such as the system 102, may be stored in a data structure in one or more memory components. Data may be retrieved from the data structure by addressing links or references to the data structure.

Although the following illustration refers to the components of FIGS. 1 and 2, it may be appreciated by those of ordinary skill in the art that the operations of the routine 400 may be also implemented in many other ways. For example, the routine 400 may be implemented, at least in part, by a processor of another remote computer or a local circuit. In addition, one or more of the operations of the routine 400 may alternatively or additionally be implemented, at least in part, by a chipset working alone or in conjunction with other software modules. Any service, circuit or application suitable for providing the techniques disclosed herein can be used in operations described herein.

With reference to FIG. 4, the routine 400 begins at operation 402, where the system 102 receives media data from the plurality of client computing devices 106(1) through 106(N). The system 102, at operation 404, selects a first portion of the media data based, at least in part, on phase data defining the first phase 302 of the telecommunications session 104, where the first portion of the media data is communicated from the system 102 to the plurality of client computing devices 106(1) through 106(N). The system 102, in operation 406, also communicates a first arrangement dataset defining a first interface arrangement associated with the first phase 302 of the telecommunications session 104 to the client computing devices 106(1) through 106(N). In this example, the first arrangement dataset causes the plurality of client computing devices 106(1) through 106(N) to display the first portion of the media data in a first number of display portions and the first number of display portions is based on, at least in part, on a number of participants of the telecommunications session 104 and a first threshold. In decision operation 408, the system 102 determines if the first phase 302 of the telecommunications session 104 is to transition to the second phase 306 of the telecommunications session 104. If the system 102 determines that the telecommunications session 104 should not transition to the second phase 306, the routine returns to operation 402 and operations 402 through 408 repeat.

If instead, the system 102 determines that the first phase 302 is to transition to the second phase 306, the routine continues to operation 410, where the system 102 selects a second portion of the media data based, at least in part, on the phase data defining the second phase 306 of the telecommunications session 104, where the second portion of the media data is communicated from the system 102 to the plurality of client computing devices 106(1) through 106(N). The system 102, in operation 412, communicates a second arrangement dataset defining a second interface arrangement associated with the second phase 306 of the telecommunications session 104 to the plurality of client computing devices 106(1) through 106(N), where the second arrangement dataset causes the plurality of client computing devices 106(1) through 106(N) to display the second portion of the media data in a second number of display portions arranged to bring focus to the second portion of the media data. The second number of display portions is based on, at least in part, on a second threshold and the second threshold limits the client computing devices 106(1) through 106(N) to display a fewer number of display portions than the first threshold. In decision operation 414, the system 102 determines if the second phase 306 of the telecommunications session 104 is to transition to a third phase 310 of the telecommunications session 104. If the system 102 determines that the telecommunications session 104 should not transition to the third phase 310, the routine returns to operation 410 and operations 410 through 414 repeat.

If instead, the system 102 determines that the second phase 306 is to transition to the third phase 310, the routine continues to operation 416, where the system 102 generates summary data of the telecommunications session 104, where the summary data includes at least one of a transcript of conversations of the telecommunications session 104 and selected video portions the telecommunications session 104. The system 102, in operation 418, also stores the summary data and the media data in a database (in or associated with the data store 138) of the system 102 and, in operation 420, communicates the summary data to the plurality of client computing devices 106(1) through 106(N). The system 102 is also configured to receive, in operation 422, input data from at one client computing device of the plurality of client computing devices 106(1) through 106(N), where the input data defines least one of the modifications to the summary data, annotations related to the summary data, and additional media data, and, in operation 424, store the input data in the database. At stage, the system 102 then determines, in decision operation 426, whether the telecommunications session 104 should be re-started (as described earlier in relation to FIG. 3). If the system 102 determines that the telecommunications session 104 is to be re-started, the routine continues to either operation 402 to re-start the telecommunications session 104 at the first phase 302 or at operation 410 to re-start the telecommunications session 104 at the second phase 306. In this example, the system 102 may re-start the telecommunications session 104 at the first phase 302 to allow new participants to join the telecommunications session 104 or the system 102 may re-start the telecommunications session 104 at the second phase 306 to continue the telecommunications session 104 with the original or reduced (e.g., some participants have left the telecommunications session 104) number of participants. If the system 102 re-starts the telecommunications session 104 at the first phase 302, the operations 402 through 426 are repeated. If, instead, the system 102 re-starts the telecommunications session 104 at the second phase 306, the operations 410 through 426 are repeated. Moreover, if the system 102 does not re-start the telecommunications session 104, the routine 400 then ends.

In this example, optionally, within the first phase 302, the system 102 may also obtain a rate indicating the rate in which participants are joining the telecommunications session 104 and determine that the first phase 302 is to transition to the second phase 306 when the rate is below a third threshold. In this example, the number of display portions may correspond to the number of participants of the telecommunications session 104 limited to the first threshold. Additionally, the system 102 may obtain data indicating a total number of participants, receive confirmation data indicating a number of participants that have joined the telecommunications session 104, and determine that the first phase 302 is to transition to the second phase 306 when the number of participants that have joined the telecommunications session 104 is within a threshold level of the total number of participants. Moreover, the system 102 may determine when a predetermined time period has lapsed from a start of the telecommunications session 104 and determine that the first phase 302 is to transition to the second phase 306 when the time period has lapsed. Furthermore, in decision operation 414, the system 102 may receive data indicating that a participant is leaving the telecommunications session 104 and determine that the second phase 306 is to transition to the third phase 310, in response to receiving data indicating that the participant is leaving the telecommunications session 104. In this example, the second interface includes the second number of display portions and a plurality of sub-portions, where the sub-portions are arranged to cover less surface area of a display surface than the second number of display portions. The second number of display portions are arranged to display salient portions of the media data and the sub-portions are arranged to display the first portion of the media data.

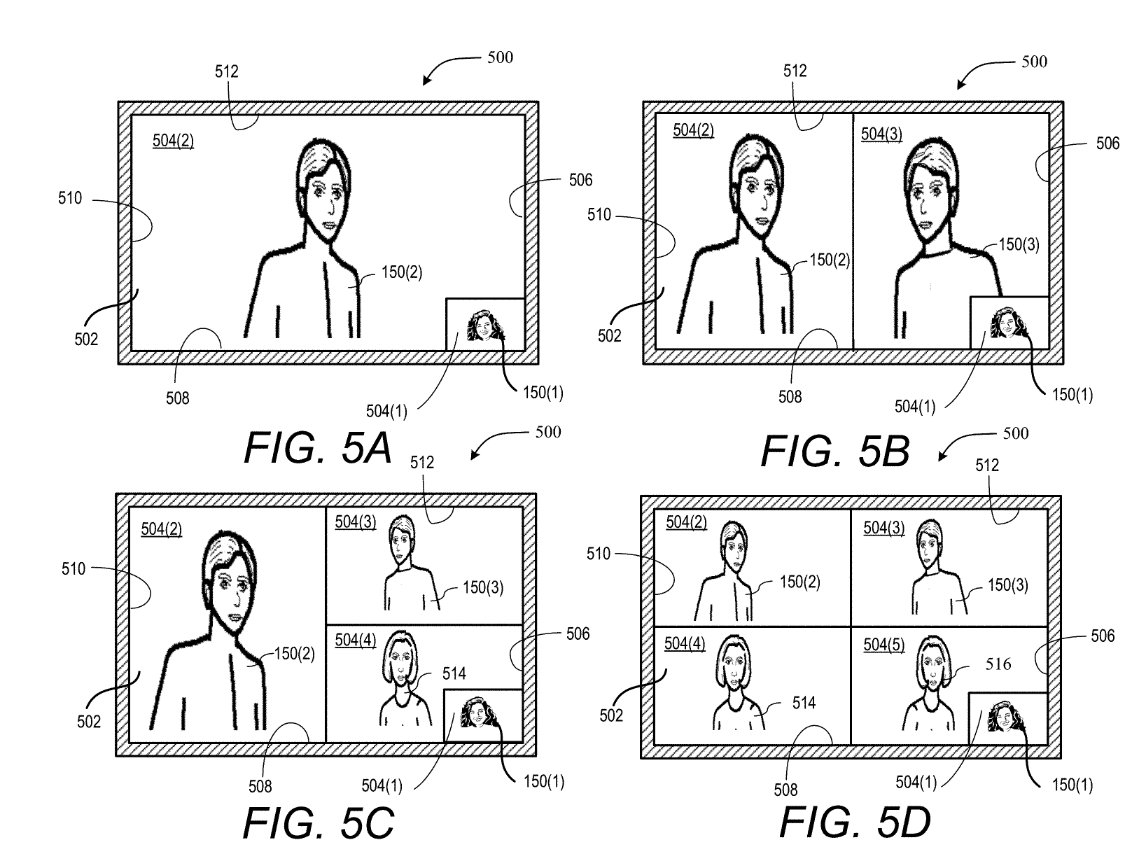

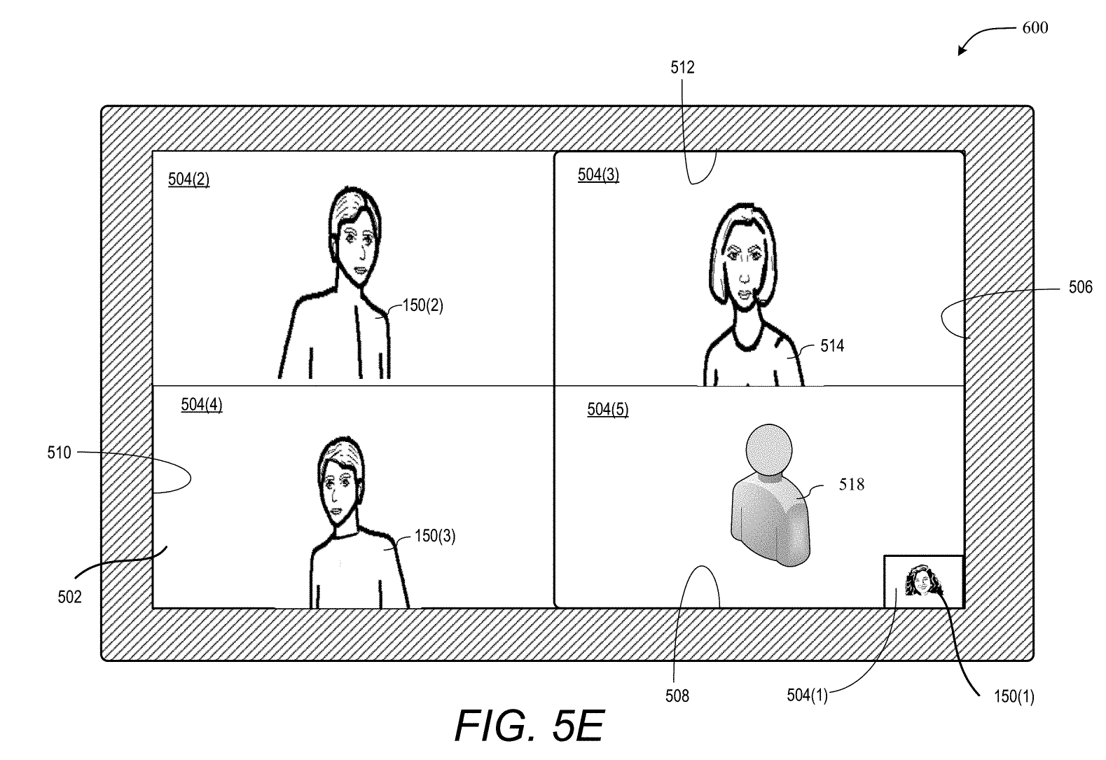

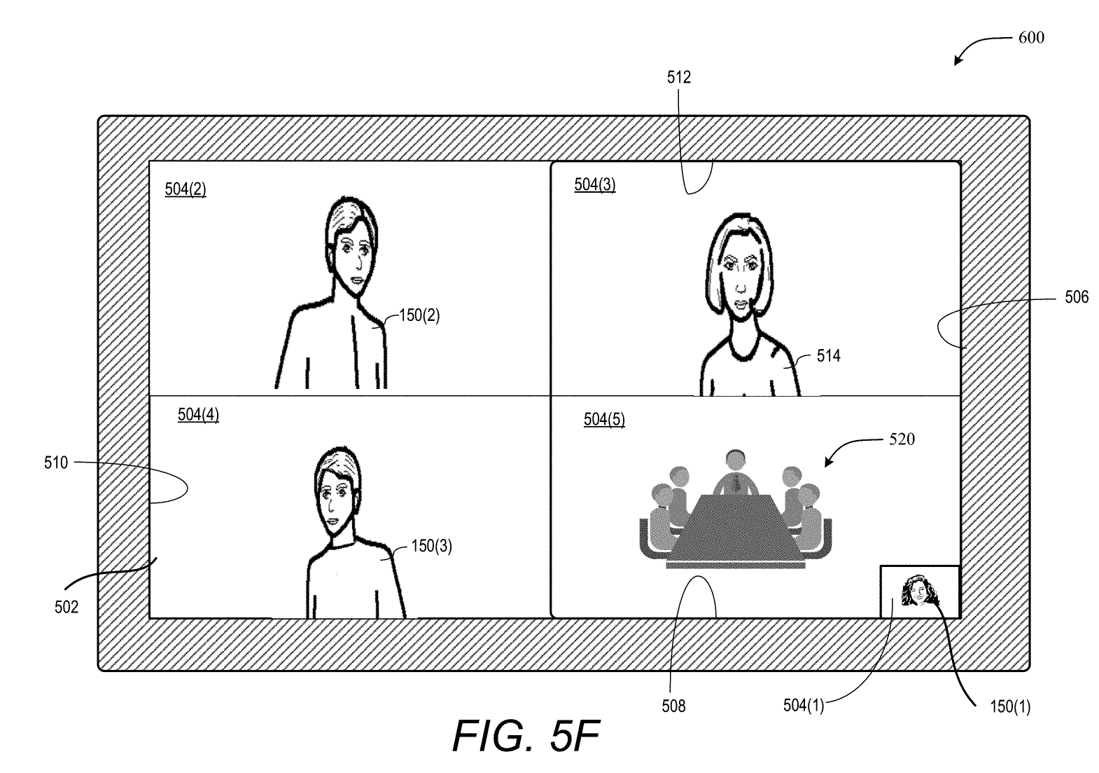

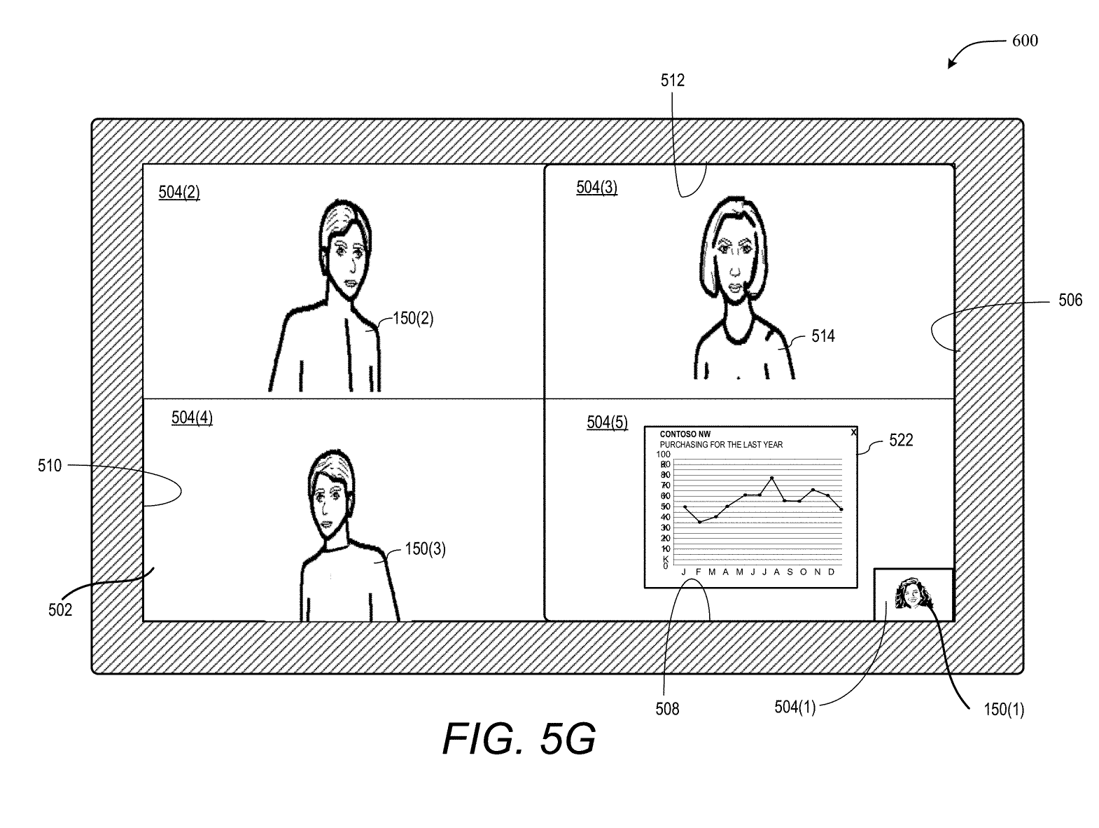

Turning to FIGS. 5A through 9, in some configurations, the techniques disclosed herein may utilize one or more predetermined interface arrangements, also referred to herein as “views.” As will be described below, the predetermined interface arrangements may include a primary section (referred to herein as a “canvas”) and secondary sections (referred to herein as “thumbnails”). In some configurations, the secondary sections may individually be configured as selectable user interface elements, for selecting streams of media associated with the individual sections. The predetermined interface arrangements may also include graphical elements providing control functionality (“control elements”) for a videoconferencing session. For instance, a graphical element may be generated on the user interface enabling a user 150(1) through 150(N) to provide content, end a session, mute one or more sounds, etc.

In one illustrative example, the techniques disclosed herein may utilize an immersive view. The immersive view may include one or more control elements. In some configurations, the control elements may be displayed to a user for a predetermined period of time and then fade after the predetermined period of time has lapsed. In response to certain types of user activity, such as hovering a pointing device over a predetermined area of the user interface, the control elements may reappear for a predetermined period of time.

The immersive view may include the presentation of people or content in a primary section and the presentation of people or content in a secondary section. The secondary sections may be displayed for a predetermined period of time and then fade after the predetermined period of time has lapsed.

One or more secondary sections may be selected by a user 150(1) through 150(N) to “pin” a particular display of content or a person to the user interface. Once the content particular secondary section is selected, that selected section does not fade over time.

In another illustrative example, the techniques disclosed herein may utilize a persistent view. The persistent view may provide one or more control elements, which may be configured as described above. In general, the persistent view is designed to provide an optimized interface for sharing content. In general, the content is shared in a primary section, in an edge-to-edge configuration, where the edge-to-edge configuration includes displaying the content edge-to-edge on a display of a client computing device 106(1) though 106(N). The persistent view may include the presentation of people (i.e., users 150(1) through 150(N)) or content in a primary section in the presentation of people or content in a secondary section. In the persistent view, the presentation of the people or content in the secondary section does not fade after a predetermined period of time.

In FIG. 5A, an example of a display of the first phase 302 of the telecommunications session 104 on a client computing device (for example, client computing device 106(1)) in communication with the telecommunications session 104 is shown with a second person joining the telecommunications session 104, where the second person is displayed edge-to-edge on a display of the client computing device 106(1) in accordance with the present disclosure. In this example, the first user interface 500 includes a canvas 502 (i.e., primary portion) that provides a stage for the telecommunications session 104. The first user interface 500 may also include one or more thumbnails 504(1) though 504(N) (i.e., secondary portions). In this example, the thumbnails 504(1) through 504(5) may include a live video stream of selected media data, etc. The selected media data, such as streaming videos, files, and applications, shared in the telecommunications session 104 may be displayed in the canvas 502 of the user interface 500. In this example, the telecommunications session 104 is shown to start with two participants that are a first user 150(1), that corresponds to the first client computing device 106(1) and a second user 150(2) that corresponds to the second client computing device 106(2). A video image of the first user 150(1) is displayed within a first thumbnail 504(1) and a video image of the second user 150(2) is displayed in a second thumbnail 504(2). In this example, the telecommunications session 104 is beginning. Since there are only two participants and one is the user 105(1) associated with the first client computing device 106(1), the first user 105(1) is shown as a small thumbnail 504(1) in the lower right-side of the first user interface 500 next to the right-side 506 and bottom-side 508 of the display displaying the user interface 500. In this example, the position and small size of the thumbnail 504(1) is to allow the first user 150(1) to see herself on the display while not interfering with the canvas 502 or thumbnails 502(2) through 502(N). Moreover, since the second user 150(2) is the only other participant in this example, the second thumbnail 504(2) is extended so as to be displayed edge-to-edge (i.e., from the right edge 506 to a left edge 510 along the sides of the display and from the bottom edge 508 to a top edge 512 alone the top and bottom of the display) along the canvas 502.

FIG. 5B is an example of another display of the first phase 302 of the telecommunications session 104 on the client computing device 106(1) with a third person (i.e., user 150(3)) joining the telecommunications session 104, where the three people 150(1), 150(2), and 150(3) are displayed edge-to-edge on the display of the client computing device 106(1) in accordance with the present disclosure. In this example, the second and third thumbnails 504(2) and 504(3) are displayed edge-to-edge along the canvas 502 but the first user 150(1) is still shown as the small thumbnail 504(1) in the low right-side of the display.

In FIG. 5C, an example of another display of the first phase 302 of the telecommunications session 104 with a fourth person 512 joining the telecommunications session 104 is shown, where the four people (i.e., users 150(1), 150(2), 150(3), and 514) are displayed edge-to-edge on the display of the client computing device 106(1) in accordance with the present disclosure. In this example, the second, third, and fourth thumbnails 504(2), 504(3), are 504(4) are displayed edge-to-edge along the canvas 502 but again the first user 150(1) is still shown as the small thumbnail 504(1) in the low right-side of the display.

Similarly, in FIG. 5D, an example of another display of the first phase 302 of the telecommunications session 104 with a fifth person (i.e., user 514) joining the telecommunications session 104 is shown, where the five people (i.e., users 150(1), 150(2), 150(3), 514, and 516) are displayed edge-to-edge on the display of the client computing device 106(1) in accordance with the present disclosure. In this example, the second, third, fourth, and fifth thumbnails 504(2), 504(3), 504(4), and 504(5) are displayed edge-to-edge along the canvas 502 but again the first user 150(1) is still shown as the small thumbnail 504(1) in the low right-side of the display.

In these examples, the canvas 502 (i.e., primary portion) displays the five users 150(1), 150(2), 150(3), 512, and 514 (i.e., participants) attending the telecommunications session 104 within one or more thumbnails 504(1) through 504(5) (i.e., secondary portions), respectively. In these examples, the first participant is the user 150(1) of the first client computing device 106(1) that is displayed on the display of the client computing device 106(1) as a small video feed in the lower right side of the display indicating that the user 150(1) is the operator of the client computing device 106(1). The second, third, fourth, and fifth users 150(2), 150(3), 514, and 516 are displayed on the display of the first client computing device 106(1) as a small video feeds displayed as thumbnails 150(1) through 150(5), respectively, indicating that the users 150(1), 150(2), 150(3), 514, and 516 are either the four other people taking part in the telecommunications session 104 (assuming there are only five participants) or the four active participants of a plurality of participants of the telecommunications session 104 that is greater than five.

Turning to FIG. 5E, an example of another display of the first phase 302 of the telecommunications session 104 with at least five people attending the telecommunications session 104 is shown where the four people 150(1), 150(2), 150(3) and 514 and one avatar 518 are displayed edge-to-edge on the display of the client computing device 106(1) in accordance with the present disclosure. Similar to the example in FIG. 5D, in this example, the second, third, fourth, and fifth thumbnails 504(2), 504(3), 504(4), and 504(5) are displayed edge-to-edge along the canvas 502 but again the first user 150(1) is shown as the small thumbnail 504(1) in the low right-side of the display. Moreover, in this example, the fifth user 516 is not shown (as in FIG. 5D) and is replaced with the avatar 518 indicating that either the fifth user 516 has exited the telecommunications session 104 or does not have a video feed and is attending the telecommunications session 104 with an audio feed. The avatar 518 may be posted picture (non-video) of the fifth user 516 or an icon or graphical figure representing a particular person (such as, for example, the fifth user 516). As an example, if the fifth user 516 experiences a loss of her video feed, the fifth user 516 may be replaced by the system 102 with the avatar 518. Similarly, if, instead, the fifth user 516 leaves the telecommunications session 104, the video feed of the fifth user 516 in thumbnail 504(5) may be replaced by the system 102 with the avatar 518. Moreover, if the fifth user 516, or another user, only have the ability to produce an audio feed without video, the system 102 may represent that user with the avatar 518.

In FIG. 5F, an example of another display of the first phase 302 of the telecommunications session 104 with a plurality of people attending telecommunications session 104 is shown where four people 150(1), 150(2), 150(3), and 514 and one group of people 520 are displayed edge-to-edge on the display of the client computing device 106(1) in accordance with the present disclosure. In this example, thumbnail 504(5) may include a group video feed of people 520 from the room of participants that may be local or remote to the location of the telecommunications session 104. Alternatively, the thumbnail 504(5) may include a plurality of sub-thumbnails (not shown) within the thumbnail 504(5) that include video feeds and/or avatars of other participants in the telecommunication session 104. Similar to the examples in FIGS. 5A through 5D, in this example, the second, third, fourth, and fifth thumbnails 504(2), 504(3), 504(4), and 504(5) are displayed edge-to-edge along the canvas 502 but again the first user 150(1) is shown as the small thumbnail 504(1) in the low right-side of the display.

In FIG. 5G, an example of another display of the first phase 302 of the telecommunications session 104 is shown with at least four people 150(1), 150(2), 150(3), and 514 attending telecommunications session 104 where the four people 150(1), 150(2), 150(3), and 514 and one type of content 510 are displayed edge-to-edge on the display of the client computing device 106(1) in accordance with the present disclosure. In this example, the content 522 may be an application or a document such as, for example, a sales report, organization chart, slide presentation, report, etc. Similar to the examples in FIGS. 5A through 5F, in this example, the second, third, fourth, and fifth thumbnails 504(2), 504(3), 504(4), and 504(5) are displayed edge-to-edge along the canvas 502 but again the first user 150(1) is shown as the small thumbnail 504(1) in the low right-side of the display.

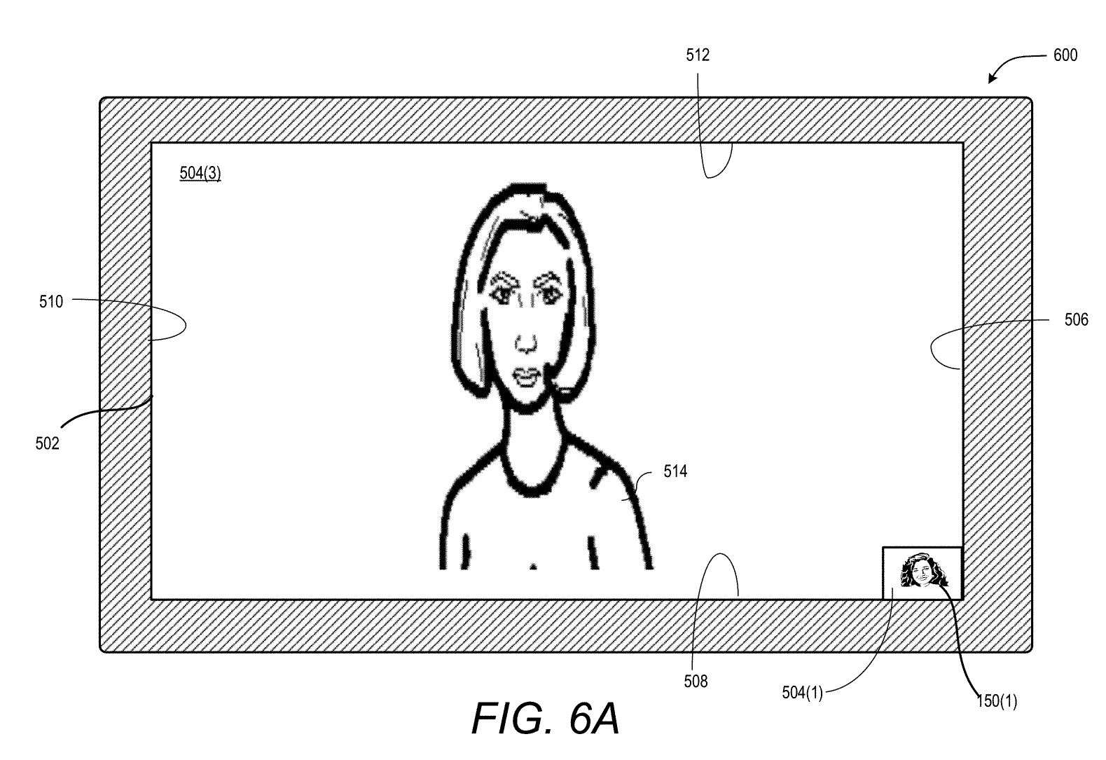

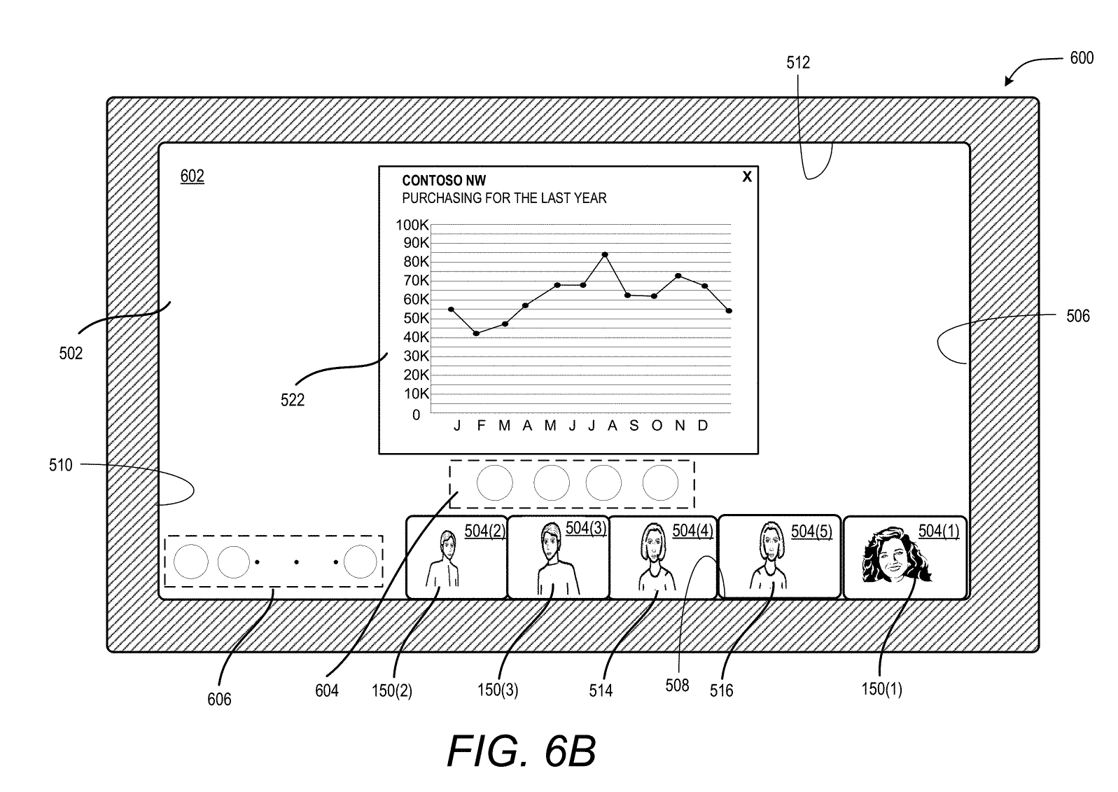

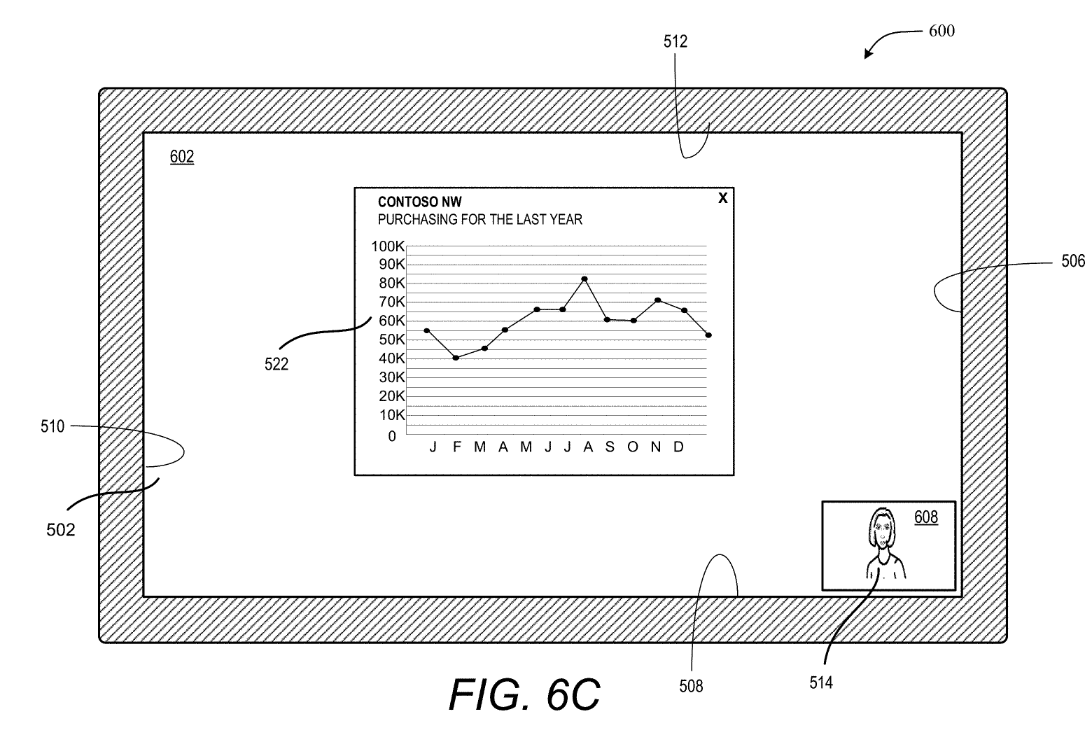

Turning to FIG. 6A, FIG. 6A is an example of a display of the second phase 306 of the telecommunications session 104 on the client computing device 106(1) in communication with the teleconferencing system 100 (of FIG. 1) showing at least two people attending the second phase 306 of the telecommunications session 104 in accordance with the present disclosure. In this example, the fourth user 514 is shown to be a dominate user such as, for example, a speaker or presenter and is shown to have a thumbnail 501(2) that is displayed edge-to-edge along the canvas 502. In this example, the fourth user 514 may be speaking or discussing information that focuses the telecommunications session 104 to related information allowing the remote participants to “follow the action” of the meeting. Similar to the examples in FIGS. 5A through 5G, in this example, the fourth thumbnail 504(3) is displayed edge-to-edge along the canvas 502 but again the first user 150(1) is shown as the small thumbnail 504(1) in the low right-side of the display.

FIG. 6B is an example of another display of the second phase 306 of the telecommunications session 104 showing content 522 being displayed and at least five people 150(1), 150(2), 150(3), 514, and 516 attending the second phase 306 of the telecommunications session 104 in accordance with the present disclosure. In this example of a permissive view, the user interface 600 includes a plurality of secondary portions that include thumbnails 504(1) through 504(5) and secondary portion 602. The thumbnails 504(1) through 504(5) of the at least five users 150(1), 150(2), 150(3), 514, and 516 are positioned towards the bottom edge 508 of the display. The content 522 is displayed in secondary portion 602 that is displayed edge-to-edge on the display with the thumbnails overlaid at the bottom 508 of the display. In this example, the user interface 600 may also include a number of core controls 604, which may be configured to control aspects of the teleconferencing session 104. For instance, a first button of the core controls 604 may disconnect a device (i.e., client computing device 106(1) though 106(N)) from the teleconferencing session 104. A second button of the core controls 503 may control the microphone of the client computing device 106(1) though 106(N), i.e., a mute button. A third button of the core controls 604 may control a camera of the client computing device 106(1) though 106(N), i.e., toggle the camera on or off. A fourth button may involve a transfer function. In response to receiving the user actuation of the fourth button, the primary device (i.e., client computing device 106(1) though 106(N)) becomes the companion device and the companion device becomes the primary device. In some configurations, the display of the core controls 604 may fade over a predetermined period of time. In such configurations, the core controls 604 may be redisplayed based on one or more actions, such as a hover or another suitable user interaction within a predetermined portion of the user interface 600. The user interface 600 may also optionally include a plurality of passive participant buttons 606 positioned at the bottom 508 of the display adjacent to the plurality of thumbnails 504(1) through 504(5). These participant buttons 606 may be utilized to see or select other participants of the telecommunication session 104 that are passive or not as active as the four active users 150(2), 150(3), 514, and 516. In this example, it is appreciated by those of ordinary skill that the thumbnails 504(1) through 504(5) may include active video feeds, or avatars represented, of the five users 150(1), 150(2), 150(3), 514, and 516.

Turning to FIG. 6C, an example of another display of the second phase 306 of the telecommunications session 104 is shown. In this example, the user interface 600 displays the content 522 in the secondary portion 602 and one person (such as, for example, the fourth user 514) in a thumbnail 608 offset from the main secondary portion 602. As an example, the thumbnail 608 may be positioned towards the right 506 and bottom 508 of the display. In this example, the system 102 allows the fourth user 514 to speak about or discuss the material described in the displayed content 522 without having any other thumbnails or images distracting the participants of the telecommunication session 104 from focusing on the material described and the speaker (i.e., fourth user 514). This assists the participants in following the action of the meeting.

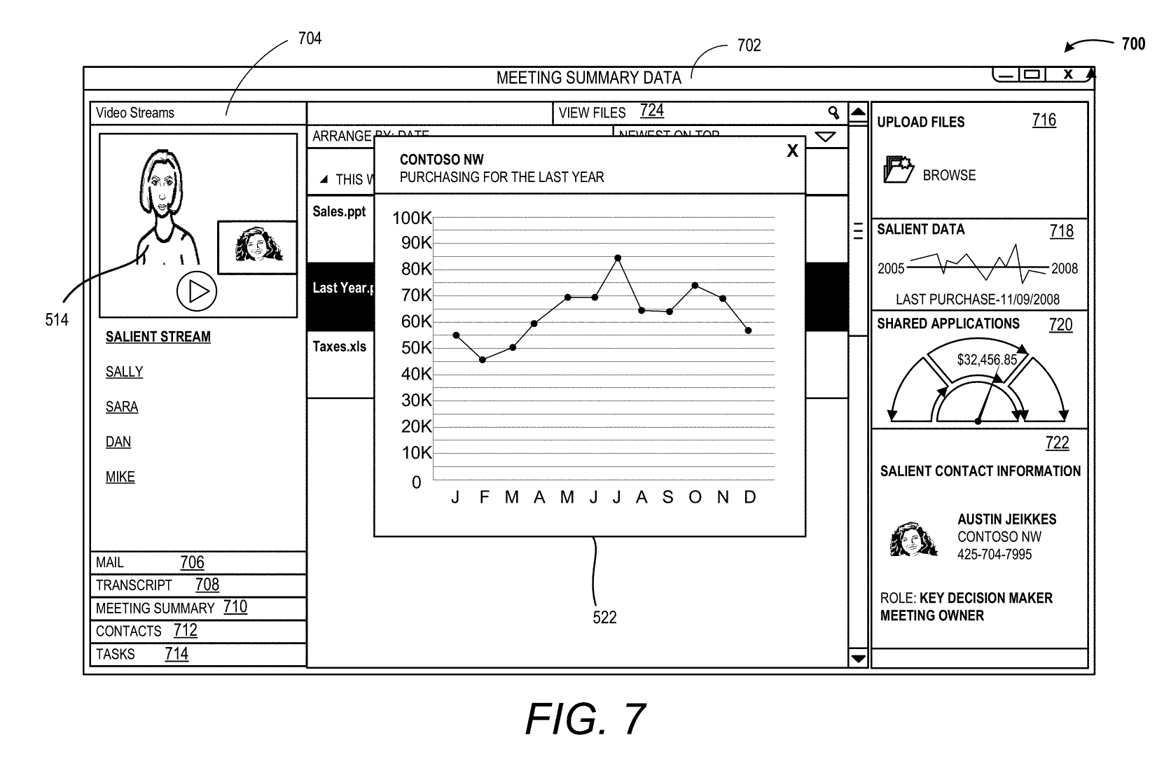

When the system 102 transitions to the third phase 310 of the telecommunication session 104 the telecommunication session 104 ends as described with relation to FIGS. 3 and 4. At that point, the system 102 performs a number of end of meeting activities 318 that includes provides the participants with meeting summary data and options and/or tools to allow the participants to either re-start the telecommunication session 104 at either the first phase 302 or second phase 306 of the telecommunication session 104 and replay the entire (or parts of) telecommunication session 104. The system 102 also allows the participants to edit the recorded telecommunication session 104 by adding notes, video, audio, upload documents, link to applications, etc. As an example, in FIG. 7, an example of a display of the third phase 310 of the telecommunications session 104 in accordance with the present disclosure. In this example, the user interface 700 may produce a display of meeting summary data 702 that may include recorded video streams 704, mail 706, transcript 708, meeting summary 710, contacts 712, tasks 714, the content 522, list of uploaded files 716, information about salient data 718, shared application 720, salient contact information 722, and view file information 724.

It is appreciated that the third phase 310 may be a personal phase in that it may be personalize for individual participants of the telecommunication sessions 104. As an example, if a participate leaves the telecommunication session 104 early and the telecommunication session 104 is still ongoing, the participate show leaves will be placed in the third phase 310 while the other participants that are still in the telecommunication session 104 will remain in the second phase 306 of the telecommunication session 104. In this example, the participant that exited early will have the system 102 perform end of meeting activities 318 that are personal to that participant.

The disclosure presented herein may be considered in view of the following clauses.

Clause A, a system hosting a telecommunications session, comprising: one or more processing units; and a computer-readable medium having encoded thereon computer-executable instructions to cause the one or more processing units to: receive media data at the system from a plurality (or at least a portion of the plurality) of client computing devices; select a first portion of the media data based, at least in part, on phase data defining a first phase of the telecommunications session, wherein the first portion of the media data is communicated from the system to the plurality of client computing devices; communicate a first arrangement dataset defining a first interface arrangement associated with the first phase of the telecommunications session to the plurality of client computing devices, wherein the first arrangement dataset causes the plurality of client computing devices to display the first portion of the media data in a first number of display portions and wherein the first number of display portions is based on, at least in part, on a number of participants of the telecommunications session and a first threshold; determine that the first phase of the telecommunications session is to transition to a second phase of the telecommunications session; in response to determining that the first phase is to transition to the second phase, select a second portion of the media data based, at least in part, on the phase data defining the second phase of the telecommunications session, wherein the second portion of the media data is communicated from the system to the plurality of client computing devices; and communicate a second arrangement dataset defining a second interface arrangement associated with the second phase of the telecommunications session to the plurality of client computing devices, wherein the second arrangement dataset causes the plurality of client computing devices to display the second portion of the media data in a second number of display portions arranged to bring focus to the second portion of the media data, wherein the second number of display portions is based on, at least in part, on a second threshold, and wherein the second threshold limits the client computing devices to display a fewer number of display portions than the first threshold.

Clause B, the example of clause A, wherein the computer-executable instructions further cause the one or more processing units to: determine that the second phase of the telecommunications session is to transition to a third phase of the telecommunications session; and in response to determining that the second phase is to transition to the third phase, generate summary data of the telecommunications session, the summary data including at least one of a transcript of conversations of the telecommunications session, selected video portions the telecommunications session, and store the summary data and the media data in a database of the system; and communicate the summary data to the plurality of client computing devices.

Clause C, the example of clause B, wherein the computer-executable instructions further cause the one or more processing units to: receive input data from the plurality of client computing devices, wherein the input data defines at least one modification to the summary data, annotations related to the summary data, and additional media data; and store the input data in the database.

Clause D, the example of clause A, B, or C, wherein the first portion of the media data comprises live video feeds generated by the plurality of client computing devices.

Clause E, the example of clause A, B, C, or D, wherein the number of display portions corresponds to the number of participants of the telecommunications session limited to the first threshold.

Clause F, the example of clause E, wherein the first threshold limits the number of display portions to four portions.

Clause G, the example of clause A, B, C, D, E, or F, wherein the computer-executable instructions further cause the one or more processing units to: obtain a rate indicating the rate in which participants are joining the telecommunications session; and determine that the first phase is to transition to the second phase when the rate is below a third threshold.

Clause H, the example of clause A, B, C, D, E, or F, wherein the computer-executable instructions further cause the one or more processing units to: obtain data indicating a total number of participants; receive confirmation data indicating a number of participants that have joined the telecommunications session; and determine that the first phase is to transition to the second phase when the number of participants that have joined the telecommunications session is within a threshold level of the total number of participants.

Clause I, the example of clause A, B, C, D, E, or F, wherein the computer-executable instructions further cause the one or more processing units to: determine when a predetermined time period has lapsed from a start of the telecommunications session; and determine that the first phase is to transition to the second phase when the time period has lapsed.

Clause J, the example of clause A, B, C, D, E, or F, wherein the computer-executable instructions further cause the one or more processing units to: determine when a second predetermined time period has lapsed from a start of the telecommunications session; and determine that the first phase is to transition to the second phase when the second time period has lapsed.

Clause K, the example of clause A, B, C, D, E, G, H, I, or J, wherein the computer-executable instructions further cause the one or more processing units to: receive data indicating that a participant is leaving the telecommunications session; and determine that the second phase is to transition to the third phase, in response to receiving data indicating that a participant is leaving the telecommunications session.

Clause L, the example of clause A, B, C, D, E, G, H, I, J, or K, wherein the second interface comprises the second number of display portions and a plurality of sub-portions, wherein the sub-portions are arranged to cover less surface area of a display surface than the second number of display portions, wherein the second number of display portions are arranged to display salient portions of the media data, and wherein the sub-portions are arranged to display the first portion of the media data.

Clause M, the example of clause A, B, C, D, E, G, H, I, J, K, or L, wherein the computer-executable instructions further cause the one or more processing units to: receive additional media data at the system from at least one additional client computing device after determining that the first phase of the telecommunications session is to transition to the second phase of the telecommunications session, wherein communicating the second arrangement dataset includes communicating the second arrangement dataset defining the second interface arrangement associated with the second phase of the telecommunications session to the plurality of client computing devices and the at least one additional client computing device, wherein the second arrangement dataset causes the plurality of client computing devices and the at least one additional client computing device to display the second portion of the media data in the second number of display portions arranged to bring focus to the second portion of the media data, wherein the second number of display portions is based on, at least in part, on the second threshold, and wherein the second threshold limits the client computing devices and at least one additional client computing device to display the fewer number of display portions than the first threshold.

Clause N, the example of clause A, B, C, D, E, G, H, I, J, K, L, or M, wherein the computer-executable instructions further cause the one or more processing units to: determine that the second phase of the telecommunications session is to transition to a third phase of the telecommunications session; generate summary data of the telecommunications session, the summary data including at least one of a transcript of conversations of the telecommunications session, selected video portions the telecommunications session; store the summary data and the media data in a database of the system; receive input media data from at least one additional client computing device after determining that the second phase of the telecommunications session is to transition to the third phase of the telecommunications session, wherein the input data defines at least one modification to the summary data, annotations related to the summary data, and additional media data; and store the input data in the database.

Clause O, a method for hosting a telecommunications session, comprising: receiving media data at the system from a plurality (or at least a portion of the plurality) of client computing devices; selecting a first portion of the media data based, at least in part, on phase data defining a first phase of the telecommunications session, wherein the first portion of the media data is communicated from the system to the plurality of client computing devices; communicating a first arrangement dataset defining a first interface arrangement associated with the first phase of the telecommunications session to the client computing devices, wherein the first arrangement dataset causes the plurality of client computing devices to display the first portion of the media data in a first number of display portions, wherein the first number of display portions is based on, at least in part, on a number of participants of the telecommunications session and a first threshold; determining that the first phase of the telecommunications session is to transition to a second phase of the telecommunications session; and in response to determining that the first phase is to transition to the second phase, selecting a second portion of the media data based, at least in part, on the phase data defining the second phase of the telecommunications session, wherein the second portion of the media data is communicated from the system to the plurality of client computing devices; and communicating a second arrangement dataset defining a second interface arrangement associated with the second phase of the telecommunications session to the plurality of client computing devices, wherein the second arrangement dataset causes the plurality of client computing devices to display the second portion of the media data in a second number of display portions arranged to bring focus to the second portion of the media data, wherein the second number of display portions is based on, at least in part, on a second threshold, and wherein the second threshold limits the client computing devices to display a fewer number of display portions than the first threshold.

Clause P, the example of clause O, further including: determining that the second phase of the telecommunications session is to transition to a third phase of the telecommunications session; and in response to determining that the second phase is to transition to the third phase, generating summary data of the telecommunications session, the summary data including at least one of a transcript of conversations of the telecommunications session, selected video portions the telecommunications session, and storing the summary data and the media data in a database of the system; and communicating the summary data to the plurality of client computing devices.

Clause Q, the example of clause O or P, further including: receiving input data from at least one client computing device of the plurality of client computing devices, wherein the input data defines at least one modification to the summary data, annotations related to the summary data, and additional media data; and storing the input data in the database.

Clause R, the example of clause O, P, or Q, wherein the number of display portions corresponds to the number of participants of the telecommunications session limited to the first threshold.

Clause S, the example of clause O, P, Q, or R, further including: obtaining a rate indicating the rate in which participants are joining the telecommunications session; and determining that the first phase is to transition to the second phase when the rate is below a third threshold.

Clause T, the example of clause O, P, or R, further including: obtaining data indicating a total number of participants; receiving confirmation data indicating a number of participants that have joined the telecommunications session; and determining that the first phase is to transition to the second phase includes when the number of participants that have joined the telecommunications session is within a threshold level of the total number of participants.

Clause U, the example of clause O, P, or R, further including: determining when a predetermined time period has lapsed from a start of the telecommunications session; and determining that the first phase is to transition to the second phase when the time period has lapsed.

Clause V, the example of clause O, P, or R, further including: determining when a second predetermined time period has lapsed from a start of the telecommunications session; and determining that the second phase is to transition to the third phase when the second time period has lapsed.

Clause W, the example of clause O, P, R, S, T, U, or V, further including: receiving data indicating that a participant is leaving the telecommunications session; and determining that the second phase is to transition to the third phase, in response to receiving data indicating that a participant is leaving the telecommunications session.

Clause X, the example of clause O, P, R, S, T, U, V, or W, wherein the second interface includes the second number of display portions and a plurality of sub-portions, wherein the sub-portions are arranged to cover less surface area of a display surface than the second number of display portions, wherein the second number of display portions are arranged to display salient portions of the media data, and wherein the sub-portions are arranged to display the first portion of the media data.

Clause Y, the example of clause O, further including: receiving additional media data at the system from at least one additional client computing device after determining that the first phase of the telecommunications session is to transition to the second phase of the telecommunications session, wherein communicating the second arrangement dataset includes communicating the second arrangement dataset defining the second interface arrangement associated with the second phase of the telecommunications session to the plurality of client computing devices and the at least one additional client computing device, wherein the second arrangement dataset causes the plurality of client computing devices and the at least one additional client computing device to display the second portion of the media data in the second number of display portions arranged to bring focus to the second portion of the media data, wherein the second number of display portions is based on, at least in part, on the second threshold, and wherein the second threshold limits the client computing devices and at least one additional client computing device to display the fewer number of display portions than the first threshold.

Clause Z, the example of clause O, further including: determining that the second phase of the telecommunications session is to transition to a third phase of the telecommunications session; generating summary data of the telecommunications session, the summary data including at least one of a transcript of conversations of the telecommunications session, selected video portions the telecommunications session; storing the summary data and the media data in a database of the system; receiving input media data from at least one additional client computing device after determining that the second phase of the telecommunications session is to transition to the third phase of the telecommunications session, wherein the input data defines at least one modification to the summary data, annotations related to the summary data, and additional media data; and storing the input data in the database.

Although the techniques have been described in language specific to structural features and/or methodological acts, it is to be understood that the appended claims are not necessarily limited to the features or acts described. Rather, the features and acts are described as example implementations of such techniques.

The operations of the example processes are illustrated in individual blocks and summarized with reference to those blocks. The processes are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as FPGAs, DSPs, or other types of accelerators.

All of the methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art. It should be emphasized that many variations and modifications may be made to the above-described examples, the elements of which are to be understood as being among other acceptable examples. All such modifications and variations are intended to be included herein within the scope of this disclosure and protected by the following claims.

1. A system hosting a telecommunications session, comprising:
one or more processing units; and
a computer-readable medium having encoded thereon computer-executable instructions to cause the one or more processing units to:
receive media data at the system from at least a portion of a plurality of client computing devices;
select a first portion of the media data based, at least in part, on phase data defining a first phase of the telecommunications session, wherein the first portion of the media data is communicated from the system to the at least the portion of the plurality of client computing devices;
communicate a first arrangement dataset defining a first interface arrangement associated with the first phase of the telecommunications session to the at least the portion of the plurality of client computing devices, wherein the first arrangement dataset causes the at least the portion of the plurality of client computing devices to display the first portion of the media data in a first number of display portions and wherein the first number of display portions is based, at least in part, on a number of participants of the telecommunications session and a first threshold;
identify, during the first phase of the telecommunication session, at least one trigger event that indicates that the first phase of the telecommunications session is to transition to a second phase of the telecommunications session, wherein the at least one trigger event corresponds to at least a rate at which participants are joining the telecommunications session falling below a threshold rate;
in response to identifying the at least one trigger event, select a second portion of the media data based, at least in part, on the phase data defining the second phase of the telecommunications session, wherein the second portion of the media data is communicated from the system to the at least the portion of the plurality of client computing devices; and
communicate a second arrangement dataset defining a second interface arrangement associated with the second phase of the telecommunications session to the plurality of client computing devices, wherein the second arrangement dataset causes the at least the portion of the plurality of client computing devices to display the second portion of the media data in a second number of display portions arranged to bring focus to the second portion of the media data, wherein the second number of display portions is based, at least in part, on a second threshold, and wherein the second threshold causes the client computing devices to display a fewer number of display portions than the first threshold.

2. The system of claim 1, wherein the computer-executable instructions further cause the one or more processing units to:
determine that the second phase of the telecommunications session is to transition to a third phase of the telecommunications session; and
in response to determining that the second phase is to transition to the third phase,
generate summary data of the telecommunications session, the summary data including at least one of a transcript of conversations of the telecommunications session, or selected video portions the telecommunications session;
store the summary data and the media data in a database of the system; and
communicate the summary data to the at least the portion of the plurality of client computing devices.

3. The system of claim 2, wherein the computer-executable instructions further cause the one or more processing units to:
receive input data from the at least the portion of the plurality of client computing devices, wherein the input data defines at least one of a modification to the summary data, annotations related to the summary data, or additional media data; and
store the input data in the database.

4. The system of claim 1, wherein the first portion of the media data comprises live video feeds generated by the at least the portion of the plurality of client computing devices.

5. The system of claim 1, wherein the first number of display portions corresponds to the number of participants of the telecommunications session limited to the first threshold.

6. The system of claim 5, wherein the first threshold limits the first number of display portions to four portions.

7-9. (canceled)

10. The system of claim 1, wherein the computer-executable instructions further cause the one or more processing units to:
receive data indicating that a participant is leaving the telecommunications session; and
determine that the second phase is to transition to the third phase, in response to receiving the data indicating that the participant is leaving the telecommunications session.

11. The system of claim 1, wherein the computer-executable instructions further cause the one or more processing units to:
determine when a second predetermined time period has lapsed from a start of the telecommunications session; and
determine that the second phase is to transition to the third phase when the second time period has lapsed.

12. The system of claim 1, wherein the second interface arrangement comprises the second number of display portions and a plurality of sub-portions,
wherein the plurality of sub-portions are arranged to cover less surface area of a display surface than the second number of display portions,
wherein the second number of display portions are arranged to display salient portions of the media data, and
wherein the plurality of sub-portions are arranged to display the first portion of the media data.

13. A system of claim 1, wherein the computer-executable instructions further cause the one or more processing units to:
receive additional media data at the system from at least one additional client computing device after determining that the first phase of the telecommunications session is to transition to the second phase of the telecommunications session,
wherein communicating the second arrangement dataset includes communicating the second arrangement dataset defining the second interface arrangement associated with the second phase of the telecommunications session to the plurality of client computing devices and the at least one additional client computing device,
wherein the second arrangement dataset causes the plurality of client computing devices and the at least one additional client computing device to display the second portion of the media data in the second number of display portions arranged to bring focus to the second portion of the media data,
wherein the second number of display portions is based, at least in part, on the second threshold, and
wherein the second threshold causes the plurality of client computing devices and at least one additional client computing device to display the fewer number of display portions than the first threshold.

14. The system of claim 1, wherein the computer-executable instructions further cause the one or more processing units to:
determine that the second phase of the telecommunications session is to transition to a third phase of the telecommunications session;
generate summary data of the telecommunications session, the summary data including at least one of a transcript of conversations of the telecommunications session, or selected video portions the telecommunications session;
store the summary data and the media data in a database of the system;
receive input media data from at least one additional client computing device after determining that the second phase of the telecommunications session is to transition to the third phase of the telecommunications session, wherein the input data defines at least one of a modification to the summary data, annotations related to the summary data, or additional media data; and
store the input data in the database.

15. A method for hosting a telecommunications session, comprising:
receiving, at a system, media data from at least a portion of a plurality of client computing devices;
selecting a first portion of the media data based, at least in part, on phase data defining a first phase of the telecommunications session,
wherein the first portion of the media data is communicated from the system to the at least the portion of the plurality of client computing devices;
communicating a first arrangement dataset defining a first interface arrangement associated with the first phase of the telecommunications session to the at least the portion of the plurality of client computing devices,
wherein the first arrangement dataset causes the at least the portion of the plurality of client computing devices to display the first portion of the media data in a first number of display portions,
wherein the first number of display portions is based, at least in part, on a number of participants of the telecommunications session and a first threshold;
determining that the first phase of the telecommunications session is to transition to a second phase of the telecommunications session based at least in part on a predetermined time period lapsing from a start of the telecommunication session;
in response to determining that the first phase is to transition to the second phase, selecting a second portion of the media data based, at least in part, on the phase data defining the second phase of the telecommunications session, wherein the second portion of the media data is communicated from the system to the at least the portion of the plurality of client computing devices; and
communicating a second arrangement dataset defining a second interface arrangement associated with the second phase of the telecommunications session to the at least the portion of the plurality of client computing devices, and
wherein the second arrangement dataset causes the at least the portion of the plurality of client computing devices to display the second portion of the media data in a second number of display portions arranged to bring focus to the second portion of the media data,
wherein the second number of display portions is based, at least in part, on a second threshold, and
wherein the second threshold limits the client computing devices to display a fewer number of display portions than the first threshold.

16. The method of claim 15, further including:
determining that the second phase of the telecommunications session is to transition to a third phase of the telecommunications session; and
in response to determining that the second phase is to transition to the third phase,
generating summary data of the telecommunications session, the summary data including at least one of a transcript of conversations of the telecommunications session, or selected video portions the telecommunications session, and
storing the summary data and the media data in a database of the system; and
communicating the summary data to the at least the portion of the plurality of client computing devices.

17. The method of claim 16, furthering including:
receiving input data from at least one client computing device of the at least the portion of the plurality of client computing devices, wherein the input data defines at least one of a modification to the summary data, annotations related to the summary data, or additional media data; and
storing the input data in the database.

18. The method of claim 16, wherein the first number of display portions corresponds to the number of participants of the telecommunications session limited to the first threshold.

19. The method of claim 16, further including:
obtaining data indicating a total number of participants; and
receiving confirmation data indicating a number of participants that have joined the telecommunications session, wherein determining that the first phase of the telecommunications session is to transition to the second phase of the telecommunications session is further based on the number of participants that have joined the telecommunications session being within a threshold level of the total number of participants.

20. A method of claim 15, further including;
determining that the second phase of the telecommunications session is to transition to a third phase of the telecommunications session;
generating summary data of the telecommunications session, the summary data including at least one of a transcript of conversations of the telecommunications session, or selected video portions the telecommunications session;
storing the summary data and the media data in a database of the system;
receiving input media data from at least one additional client computing device after determining that the second phase of the telecommunications session is to transition to the third phase of the telecommunications session, wherein the input data defines at least one of a modification to the summary data, annotations related to the summary data, or additional media data; and
storing the input data in the database.

21. A system hosting a telecommunications session, comprising:
one or more processing units; and
a computer-readable medium having encoded thereon computer-executable instructions to cause the one or more processing units to:
receive media data at the system from at least a portion of a plurality of client computing devices;
select a first portion of the media data based, at least in part, on phase data defining a first phase of the telecommunications session, wherein the first portion of the media data is communicated from the system to the at least the portion of the plurality of client computing devices;
communicate a first arrangement dataset defining a first interface arrangement associated with the first phase of the telecommunications session to the at least the portion of the plurality of client computing devices, wherein the first arrangement dataset causes the at least the portion of the plurality of client computing devices to display the first portion of the media data in a first number of display portions and wherein the first number of display portions is based, at least in part, on a number of participants of the telecommunications session and a first threshold;
identify, during the first phase of the telecommunication session, at least one trigger event that indicates that the first phase of the telecommunications session is to transition to a second phase of the telecommunications session, wherein the at least one trigger event corresponds to at least a number of participants that have joined the session reaching a threshold level of a total number of participants;
in response to identifying the at least one trigger event, select a second portion of the media data based, at least in part, on the phase data defining the second phase of the telecommunications session, wherein the second portion of the media data is communicated from the system to the at least the portion of the plurality of client computing devices; and
communicate a second arrangement dataset defining a second interface arrangement associated with the second phase of the telecommunications session to the plurality of client computing devices, wherein the second arrangement dataset causes the at least the portion of the plurality of client computing devices to display the second portion of the media data in a second number of display portions arranged to bring focus to the second portion of the media data, wherein the second number of display portions is based, at least in part, on a second threshold, and wherein the second threshold causes the client computing devices to display a fewer number of display portions than the first threshold.

22. The system of claim 21, wherein the computer-executable instructions further cause the one or more processing units to:
determine that the second phase of the telecommunications session is to transition to a third phase of the telecommunications session; and
in response to determining that the second phase is to transition to the third phase,
generate summary data of the telecommunications session, the summary data including at least one of a transcript of conversations of the telecommunications session, or selected video portions the telecommunications session;
store the summary data and the media data in a database of the system; and
communicate the summary data to the at least the portion of the plurality of client computing devices.

23. The system of claim 21, wherein the computer-executable instructions further cause the one or more processing units to:
receive data indicating that a participant is leaving the telecommunications session; and
determine that the second phase is to transition to the third phase, in response to receiving the data indicating that the participant is leaving the telecommunications session.
